(19) United States
(12) Patent Application Publication
(10) Pub. No.: US 2026/0169951 A1
(43) Pub. Date: Jun. 18, 2026

(54) CONSTANT QUEUE PAIR SUPPORT FOR CONCURRENT MULTI-COMMUNICATORS OVER REMOTE DIRECT MEMORY ACCESS OVER CONVERGED ETHERNET, GENERATING SUPER-RESOLUTION OF UV TEXTURES FOR DIGITAL HUMANS & PATH RECOVERY FROM LINK FAILURES FOR MULTI-PATH TRANSPORT IN DATACENTERS

(71) Applicant: Meta Platforms, Inc., Menlo Park, CA (US)

(72) Inventors: Lars Paul Huse, Oppegård (NO); Pankaj Kansal, Fremont, CA (US); Nicolaas Johannes Viljoen, Oakland, CA (US); Zeeshan Altaf Lokhandwala, Redwood City, CA (US); Ana Zehtabioskuie, Woodside, CA (US); Wesley Bland, Nolensviie, TN (US); Arvind Srinivasan, San Jose, CA (US); Aayush Prakash, Fremont, CA (US); Justin Dean Theiss, San Francisco, CA (US); Ved Kushwaha, Cupertino, CA (US)

(21) Appl. No.: 19/425,646

(22) Filed: Dec. 18, 2025

Related U.S. Application Data
(60) Provisional application No. 63/735,838, filed on Dec. 18, 2024.
(60) Provisional application No. 63/737,598, filed on Dec. 20, 2024.
(60) Provisional application No. 63/758,233, filed on Feb. 13, 2025.

(51) Int. Cl. G06F 15/173; G06F 12/123; G06T 3/4053

(52) U.S. Cl. CPC G06F 15/17331; G06F 12/123; G06T 3/4053; G06T 2207/10064; G06T 2207/20081

(57) ABSTRACT

In some implementations, a device may include receiving a ready byte update, via an initiator (e.g., sender), corresponding to a local ready bytes table entry. A work queue element (WQE) may initiate a WAIT WQE to retrieve the ready byte update. Responsive to receiving the ready byte update, a remote direct memory access (RDMA) write may write to a target base table. The initiator may indicate that an initiator is ready to receive data. The target (e.g., receiver) may set, via a SET WQE, the ready byte to a pending status. The CPU may load the target address from the target base table, add the library provided offset associated with the WQE and insert it into the RDMA write with immediate. Resulting, in a generation of a completion queue entry (CQE). The initiator may receive, responsive to the CQE, a SET WQE to set the ready byte to available.

### CROSS-REFERENCE TO RELATED APPLICATIONS

This application claims priority to U.S. Provisional Application No. 63/735,838, filed Dec. 18, 2024, entitled “Constant Queue Pair Support For Concurrent Multi-Communicators Over Remote Direct Memory Access Over Converged Ethernet,” and U.S. Provisional Application No. 63/737,598, filed Dec. 20, 2024, entitled “Systems And Methods For Generating Super-Resolution of UV Textures For Digital Humans,” and U.S. Provisional Application No. 63/758,233, filed Feb. 13, 2025, entitled “Path Recovery From Link Failures For Multi-Path Transport In Datacenters,” which are incorporated by reference herein in their entireties.

### TECHNOLOGICAL FIELD

The present disclosure generally relates to methods, apparatuses, and computer program products for communication technology, specifically to a remote data access method and device.

### BACKGROUND

Large-scale data centers are the backbone of modern computing, supporting a vast array of applications and services that drive global communication, commerce, and innovation. These massive facilities are used by tech giants, cloud providers, enterprises, or the like to store, process, and distribute enormous amounts of data, enabling cloud computing, social media, e-commerce, online search, and big data analytics.

As data center technology is rapidly evolving, with advancements in areas such as artificial intelligence, machine learning, and the Internet of Things (IoT) driving demand for more powerful, efficient, and sustainable data centers. In some examples, data centers may experience delays in data transfer due to an increased number of data packets being transferred between network devices (e.g., computing devices, servers, storage systems, high-computing environments, cloud infrastructure, or the like).

Many data centers may utilize a common networking communication protocol called RDMA over Converged Ethernet (RoCE), enabling remote direct memory access (RDMA) over an Ethernet network. RoCE may allow for high-speed, low-latency interconnection technology that may be used for communication between one or more network devices which may be used to transmit data between a plurality of network devices.

### BRIEF SUMMARY

Various systems, methods, and devices are described for concurrently sending messages between one or more devices, where a queue pair (QP) may be utilized for one or more messages. Reliable communication over a single QP may be limited to transporting data between one or more devices in the communication network.

In an example, systems, methods, or devices may include receiving a request associated with sending data (e.g., one or more messages) over a network (e.g., ethernet network). The request may issue a remote direct memory access (RDMA). As a result, a receive work request may be posted (e.g., transmitted or broadcasted) via a sender. The receiver may issue and RDMA write a ready byte to indicate that the receiver is ready to receive data from the sender. The method may also include initiating a RDMA to write to a target base table. The remote direct memory access (RDMA) may indicate that the receiver is ready to receive data from the sender. The ready byte may correspond to a local ready byte table and target a target base table. The sender may have been in a WAIT based on a WAIT work queue element prior to receiving the ready byte. The method may further include, setting the ready byte to a pending status based on a SET work queue element. In response, to the pending status the receiver may receive the data from the sender. The method may include, generating a completion queue entry in response to receiving the data from the sender. The receiver may receive a SET work queue element configured to set the ready byte to available for one or more subsequent requests, messages, data, transactions, or the like.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The summary, as well as the following detailed description, is further understood when read in conjunction with the appended drawings. For the purpose of illustrating the disclosed subject matter, there are shown in the drawings examples of the disclosed subject matter; however, the disclosed subject matter is not limited to the specific methods, compositions, and devices disclosed. In addition, the drawings are not necessarily drawn to scale. In the drawings:

FIG. 1 illustrates an example system, in accordance with an example of the present disclosure.

FIG. 2A illustrates an example method, in accordance with an example of the present disclosure.

FIG. 2B illustrates an example method, in accordance with an example of the present disclosure.

FIG. 3 illustrates an example computing device in accordance with an example of the present disclosure.

FIG. 4 is a diagram of an exemplary computing system in accordance with an example of the present disclosure.

FIG. 5 illustrates a diagram of an exemplary network environment in accordance with one or more example aspects of the subject technology.

FIG. 6 illustrates a diagram of an exemplary communication device in accordance with one or more example aspects of the subject technology.

FIG. 7 illustrates an exemplary computing system in accordance with one or more example aspects of the subject technology.

FIG. 8 illustrates a machine learning and training model framework in accordance with example aspects of the present disclosure.

FIG. 9 illustrates a rendered image of a hand sampled 1 k resolution (left), and of a 4 k super resolution of the hand (right), in accordance with example aspects of the present disclosure.

FIG. 10 illustrates UV textured images of an eye in a sampled 1 k resolution (left), and a 4 k super resolution of the eye (right), in accordance with example aspects of the present disclosure.

FIG. 11 illustrates UV textured images of a lip in a sampled 1 k resolution (left), and a 4 k super resolution of the lip (right), in accordance with example aspects of the present disclosure.

FIG. 12 illustrates UV textured images of fingertips in a sampled 1 k resolution (left), and a 4 k super resolution of the fingertips (right), in accordance with example aspects of the present disclosure.

FIG. 13 illustrates UV textured images of knuckles in a sampled 1 k resolution (left), and a 4 k super resolution of the knuckles (right), in accordance with example aspects of the present disclosure.

FIG. 14 illustrates UV textured images of a shoulder in a sampled 1 k resolution (left), and a 4 k super resolution of the shoulder (right), in accordance with example aspects of the present disclosure.

FIG. 15 illustrates UV textured images of a knee in a sampled 1 k resolution (left), and a 4 k super resolution of the knee (right), in accordance with example aspects of the present disclosure.

FIG. 16 illustrates a system for UV texture generation in accordance with example aspects of the present disclosure.

FIG. 17 illustrates a digital human rendering with UV textures in accordance with example aspects of the present disclosure.

FIG. 18 illustrates UV textured images of a face in a sampled 1 k resolution (left), and a 4 k super resolution of the face (right), in accordance with example aspects of the present disclosure.

FIG. 19 illustrates an example of a network device of a system in which data may be shared between devices, in accordance with example aspects of the present disclosure.

FIG. 20 illustrates a block diagram showing an exemplary embodiment of a system, in accordance with example aspects of the present disclosure.

FIG. 21 illustrates a flowchart showing an exemplary process for transmitting data, in accordance with example aspects of the present disclosure.

The figures depict various examples for purposes of illustration only. One skilled in the art will readily recognize from the following discussion that alternative examples of the structures and methods illustrated herein may be employed without departing from the principles described herein.

### A. Constant Queue Pair Support for Concurrent Multi-Communicators Over Remote Direct Memory Access Over Converged Ethernet

### DETAILED DESCRIPTION

Some examples of the present disclosure will now be described more fully hereinafter with reference to the accompanying drawings, in which some, but not all examples of the invention are shown. Indeed, various examples of the invention may be embodied in many different forms and should not be construed as limited to the examples set forth herein. Like reference numerals refer to like elements throughout. As used herein, the terms “data,” “content,” “information” and similar terms may be used interchangeably to refer to data capable of being transmitted, received or stored in accordance with examples of the invention. Moreover, the term “exemplary”, as used herein, is not provided to convey any qualitative assessment, but instead merely to convey an illustration of an example. Thus, use of any such terms should not be taken to limit the spirit and scope of examples of the invention.

As referred to herein, the terms “sender,” “sender side,” “local side,” and similar terms may be used interchangeably to refer to a device, system, or application that may initiate the transfer of data to a remote destination (e.g., receiver side). The sender side may include servers, storage systems, applications, or network devices that transmit data over a network or internet connection. The sender side may include functions and methods for preparing and transmitting the data, ensuring its integrity and accuracy, and managing the communication protocol used for the transfer, including tasks such as data encoding, packetization, error detection and correction, and protocol-specific processing.

As referred to herein, the terms “receiver,” “remote side,” “receiver side,” and similar terms may be used interchangeably to refer to a device, system, or application that may receive data transmitted from a sender. This can include servers, storage systems, applications, or network devices that accept data over a network or internet connection. The receiver side may include functions and methods for processing and handling the incoming data, ensuring its integrity and accuracy, and managing the communication protocol used for the transfer of data.

Large-scale data centers are the backbone of modern computing, supporting a vast array of applications and services that drive global communication, commerce, and innovation. These massive facilities are used by tech giants, cloud providers, enterprises, or the like to store, process, and distribute enormous amounts of data, enabling cloud computing, social media, e-commerce, online search, or big data analytics.

As data center technology is rapidly evolving, with advancements in areas such as artificial intelligence, machine learning, or the Internet of Things (IoT) driving demand for more powerful, efficient, and sustainable data centers. In some examples, data centers may experience delays in data transfer due to a combination of increased number of data packets being transferred, congestion of the data packet transfer, loss of packets during data transfer, or out of order data packet transmission.

Many entities may use an industry standard networking communication protocol remote direct memory access over Converged Ethernet (RoCE). RoCE may enable remote direct memory access (RDMA) over an Ethernet network. RoCE may facilitate communication between one or more network devices. In an example, RoCE may allow one or more network device to access the memory of another network device without involving the network device's operating system or central processing unit (CPU). Current methodologies utilized in RoCE to transmit data or information with high-speed and low-latency may be send-receive or RDMA based semantics. In some scenarios, when a message (e.g., data or information) is sent between a sender to a receiver over RoCE the system may be limited to single private communication domain delivery and not sufficient for high traffic scenarios (e.g., two or more messages being sent concurrently). Conventionally, a sender may post a send request to an RoCE adapter specifying the destination address, queue pair (QP), or message size. In response to the send request, the sender may then transmit the message over the RoCE network to the receiver. However, if the receiver has not posted a matching receive request, the RoCE adapter may generate a Receiver Not Ready Negative Acknowledgement (RNR NAK) packet, indicating that the receiver is not ready to accept the message. In response to receiving the RNR NAK packet, the sender may suspend the transmission of data and retry the send operation after a specified time period (i.e., a rendezvous protocol). When the receiver posts a matching receive request, the sender may retransmit the message, and the receiver may acknowledge the receipt of the message with an acknowledgement (ACK) packet sent to the sender.

By leveraging send-receive semantics and RNR NAK methodologies, RoCE may ensure reliable, in-order delivery of messages, even in scenarios where receivers are not immediately ready. However, due to the sequential process of the rendezvous protocol inherent in RNR NAK the current communication technologies may not be sufficient for more robust computing environments that may transmit messages concurrently. The sequential process may require as each message is received an individual acknowledgement and potential retries. The common methodologies may also limit the resource allocation available to the system. Send-receive semantics may utilize the receiver to allocate buffer space for each incoming message. As such, the management of concurrent messages may introduce temporal buffering. Temporal buffering may require a plurality of buffer allocations, complex buffer management, overhead in matching receive request to incoming message, and increased resource utilization, which may strain the receivers resources and reduce overall performance.

Delays in large-scale data centers and network environments can occur when there is an increase in round-trip time (RTT), which is the time it takes for a data packet to travel from the sender to the receiver and back. This increased RTT can cause delays in data transmission, processing, and storage, ultimately affecting the overall performance of the data center. For example, in a distributed database, an increase in RTT can slow down data replication and synchronization, leading to delays in data availability and consistency. Similarly, in cloud computing environments, higher RTT can result in slower response times for user requests, impacting application performance and user experience. Furthermore, increased RTT can also amplify the effects of network congestion, packet loss, and errors, making it challenging to maintain high availability and reliability in large-scale data centers.

Although current methodologies may effectively allow for reliable, in-order delivery of messages, and high performance, these methodologies may be insufficient for systems that may require messages to be sent concurrently. In some scenarios involving concurrent message delivery, the current methodologies may result in increased error rates, packet loss, out of order completion requests, or retransmission. As such, there may be a need for a more effective, efficient, or flexible method to concurrently deliver a message over IB.

In an example, a method may utilize a QP for transmission of one or more messages. In an example, a sender may receive a ready byte corresponding to a local ready byte table. A work queue element may have been initiated to allow the sender to receive the ready byte. The reception of the ready byte may initiate a remote direct memory access to write to a target base table. The RDMA write may indicate that the receiver is ready to receive data from the sender. In response, the ready byte may be set to a pending status via a SET work queue element. The data may be received from the sender. A completion queue entry may be generated in response to the data being received at the sender. As a result, the sender may receive a SET work queue element configured to set the ready byte to available. This communication protocol as defined may eliminate the use of RNR NAK, and allow for efficient transfer of concurrent messages.

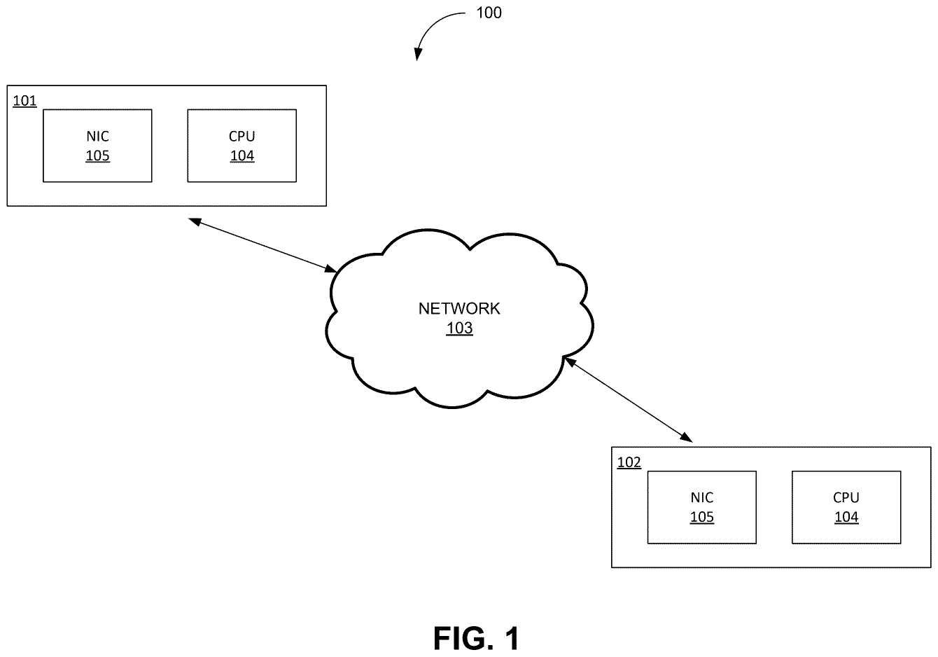

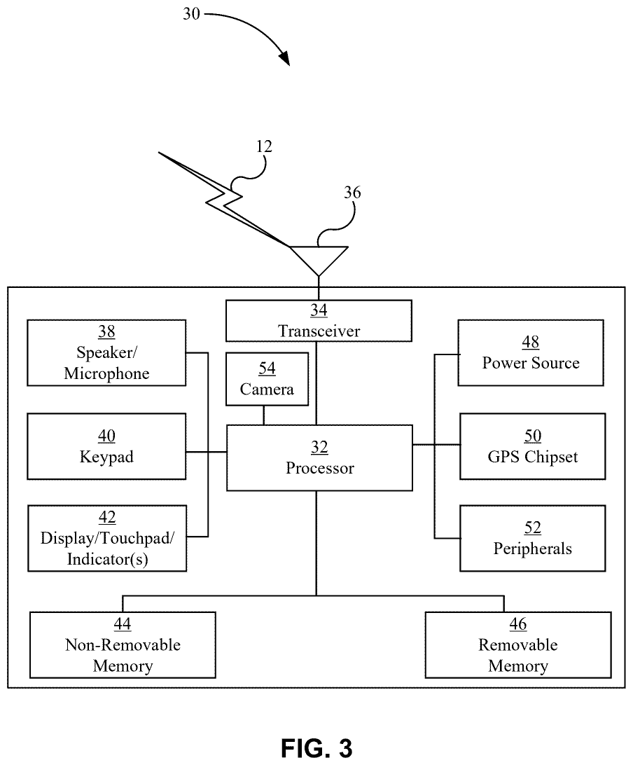

FIG. 1 illustrates an example system 100 according to example aspects of the present disclosure. The system 100 may be capable of facilitating the transmission of data among routers, switches, gateways, servers, users, servers, databases, nodes, or any combination thereof. The system 100 may include one or more computing devices 101, 102 (also may be referred to herein as device 101, 102 or nodes 101, 102) that may communicate over a network 103. In some examples, devices 101, 102 may be examples of user equipment (UE) (e.g., UE 30 of FIG. 3).

In some examples, device 101 and device 102 may be associated with an individual (e.g., a user), entity (e.g., organization), node (e.g., accelerometer), or the like that may interact or communicate with another device 101 or device 102. Data server(s) associated with network device 110. In some examples, one or more users may use one or more devices (e.g., node 101, node 102) to access, send data to, and/or receive data over network 103 to another device (e.g., device 101, device 102).

One or more devices 101, 102 may be an electronic device including hardware, software, or embedded logic components or a combination of two or more such components and capable of carrying out the appropriate functionalities implemented or supported by the devices 101, 102. As an example and not by way of limitation, devices 101, 102 may comprise or may be a computer system such as for example, a desktop computer, notebook or laptop computer, netbook, a tablet computer (e.g., smart tablet), a server, a storage controller, a storage device, e-book reader, global positioning system (GPS) device, personal digital assistant (PDA), handheld electronic device, cellular telephone, smartphone, augmented/virtual reality device, other suitable electronic device, or any suitable combination thereof. This disclosure contemplates any suitable device(s) (e.g., devices 101, 102).

This disclosure contemplates any suitable network 103. As an example and not by way of limitation, one or more portions of network 103 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. In some examples, network 103 may include one or more networks 105. In particular examples, one or more network 103 may include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular examples, one or more links may each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links.

One of the one or more devices 101, 102 may comprise a processor, as discussed herein as a Central processing Unit (CPU) 104. The CPU 104 may be programmed in in software. In some examples, the one or more devices 101, 102 may comprise a Network Interface Controller (NIC) 105 (also may be referred to herein as Host Channel Adapter (HCA) 105). In an example, one of the one or more devices 101, 102 may be a sender or a receiver. It is contemplated that one of the one or more devices 101, 102, may be a sender at times and a receiver at other times. In some alternate examples, one or more devices 101, 102 may be only a sender or only a receiver.

In some examples, one or more devices 101, 102 may comprise a messaging engine (ME). The ME may comprise a software library or a communication library (also may be referred to herein as library). The library may be a collection of pre-written code and APIs that may enable developers to efficiently implement communication protocols and interfaces between applications, systems, or devices. These libraries may provide a layer of abstraction, hiding the complexity of underlying network protocols, hardware, and software components. In some examples, the library may generate Work Queue Elements (WQEs) for the sender and receiver that may describe a communication pattern. The generated WQEs may be bundled together in a work packet and sent to a CPU (e.g., CPU 104). In such examples, the WQEs may be scheduled. The library may contain metadata configured to facilitate scheduling in the form of an attribute field. The library may express dependencies (e.g., a “flow control”) for scheduling WQEs. For example, a send WQE may be dependent on a receive WQE having been completed (e.g., the received data is guaranteed to have a place in memory before the data is sent or retransmitted). As such, a send WQE may be completed before the transmitted buffer is reused by a receive WQE guarding against data races.

In some examples, there may be one or more rules associated with the scheduling of the generated WQEs. One rule may be that WQEs with the same tag must be scheduled on the same ME. This rule may indicate that the WQEs may utilize the same QPs and NICs. Another rule may be that WQEs that use the same ID need to be on different MEs. This rule may ensure that the generated WQEs may not interfere with network traffic generated by other libraries.

For example, when a WQE may contain different IDs and the same tag, the WQE may be scheduled on the same ME to be executed simultaneously. In some examples there may be a limit to the number of WQE on the same ME such that the resources associated with a QP are not overused.

For example, when WQEs have the same ID and tag, the WQEs may not be scheduled simultaneously. In this example, a new WQE with the matching tag may be blocked until the previous WQE with the same tag has been completed (e.g., transmitted).

For example, when WQEs have different tags, the WQEs may be scheduled on any ME associated with the system. The implementation of the rules, as mentioned above may configured using one or more Work Queue Elements.

In some examples, library may comprise programmable instructions or data structures associated with a WQE. The WQE may be a descriptor that contains a command or operation configured to be executed by the HCA 105 or the CPU 104. WQE may be of various types configured perform various operations. For example, CPU 104 may include at least one or more WQE types, such as but not limited to, WAIT, SET, COPY, or the like, or any combination thereof. The WAIT WQE may be configured to wait for a library provided value to equal a predetermined value in a local address associated with a local base table (e.g., within the memory associated with the CPU associated with a device 101). The SET WQE may be configured to set a library defined value (e.g., set an address to a specific local address in the library associated with a local base table). The COPY WQE may be configured to, in response to sending information comprising metadata (e.g., data, data packets, a message, or the like) between two devices, copy the local address associated with the sender (e.g., device 101) to the local address associated with the receiver (e.g., device 102).

In an example, the one or more devices 101, 102 may comprise a data store (e.g., a memory). The data store may be used to store various types of information. In particular examples, the information stored in the data store may be organized according to specific data structures. In particular examples, each of the data stores may be a relational, columnar, correlation, or other suitable database. The memory may be configured to keep track of a devices (e.g., device 101 or device 102) readiness to receive a message based on the ID and QP associated with a message. The message may indicate the target (e.g., receiver) is ready to receive data, data packets, or the like. The memory may comprise a plurality of tables. The plurality of tables may be replicated on each device associated with the system 100. The plurality of tables may include at least one of: device table addresses, local base table, target base table, local ready bytes, or the like.

The device table addresses may be data structure associated with a library (e.g., software library or communication library). The device table addresses may be associated with a host memory (e.g., data store). The device table may store the addresses of the plurality of tables associated with the receiver device (e.g., device 102).

The local base table may be a set of local device addresses for one or more buffers. The one or more buffers may be provided by the receiver to indicate the corresponding location data may be sent. The local base table may be allocated and populated by a library. Local base tables may be potentially associated with WQEs using the SET WQE type. The local base table may contain entries for all communication peers (e.g., every connection between one or more devices). The ME may utilize the local base table to match each local device address, via the COPY WQE type. The COPY WQE may be utilized by a CPU (e.g., CPU 104) to identify the targeted base table for reception of data. The local device address may be assigned in response to a request to transmit data.

The target base table may be a table that holds information that the receiver shares, via the local base table, with the sender by using Remote Direct Memory Access (RDMA). The RDMA may write directly into the target base table, individual entries associated with the local base table. The target base table may store the target addresses for the sender and the ME slot index (e.g., COPY WQE). In an example when the sender may write data to the receiver, via RDMA, the ME may use this target address plus an offset. The offset may be provided by the library in the WQE. The ME may use the target address to calculate where to write the data in the target base table. The ME may write (e.g., load) the target address into the corresponding WQE (e.g., WAIT, SET, or COPY). In some examples, the target base table may store a Remote Key (Rkey) associated with a target buffer. The Rkey may be provided to the table as the target address is written via RDMA to the target base table. The Rkey may be a unique identifier utilized in RDMA operations to authenticate and authorize access to a remote memory region (e.g., the location of the target buffer).

Each of the one or more devices 101, 102 may comprise a set of ready byte tables (e.g., a local base table and a target base table). The ready byte tables may be readable (e.g., associated with a local base table) or writable (e.g., associated with a target base table) from the NIC 105 or CPU 104 associated with the device (e.g., device 101 or device 102). Remote ready bytes may indicate when the initiator (e.g., sender) may send data to the target(e.g., receiver), which may initiate an RDMA “Write with Immediate” of the payload. The ready byte table may have a set of bytes for one or more QPs and a library function to map to index based on QP and sender-receiver sequence. The bytes may be of any suitable number that may change in response to an address not being available. For example, the bytes may be initialized to be zero to indicate that all target addresses are available for payload transfer.

Local ready bytes table may be a table that stores a set of bytes for the target (e.g., receiver) to track when the initiator (e.g., sender) is ready to receive a ready byte from the target. The ready byte from the target may inform the initiator (e.g., sender) that the target is available to receive data (e.g., has space in the memory associated with the transferred data). The structure of the local ready bytes table may mirror the structure of the remote ready bytes table associated with the target base table. The ready bytes table associated with the local ready bytes table may be initialized to zero to indicate that the target is ready to engage with the initiator in response to the RDMA being configured by the target.

In an example, the library may exchange (e.g., transfer) one or more device addresses associated with the target base table, where the device addresses may be ranked during a communicator creation time using out of band (OOB) mechanisms. In an example, the library may exchange (e.g., transfer) one or more device addressed associated with the target base table, where the one or more device addresses may be assigned a predetermined fixed address. The predetermined fixed address may be stored to non-allocatable memory, where a non-allocatable memory may refer to a region of memory that cannot be allocated or registered for RDMA operations. As such, the receiver may populate values in the local ready bytes table, associated with the one or more ranked device addresses, enabling RDMA write.

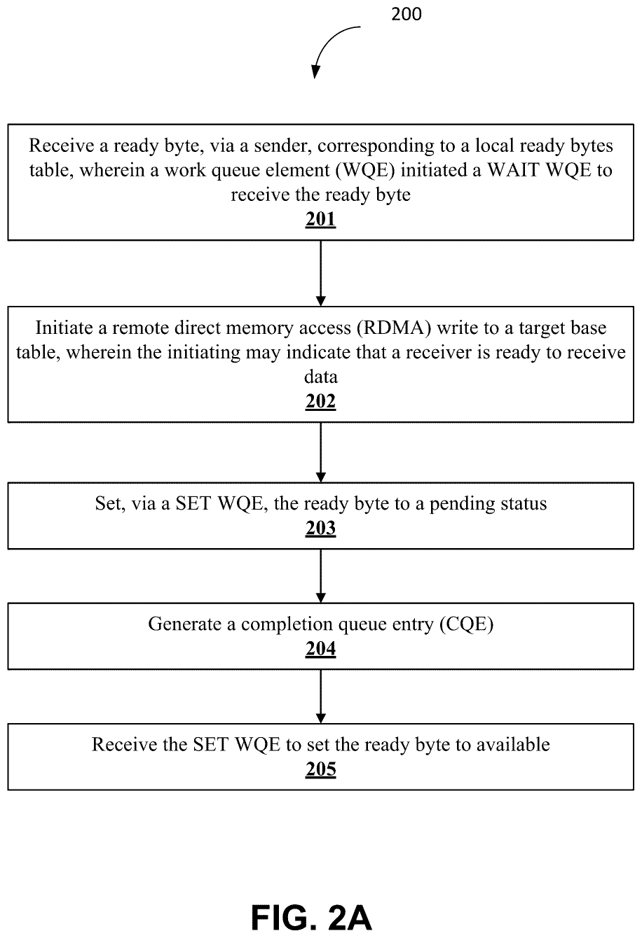

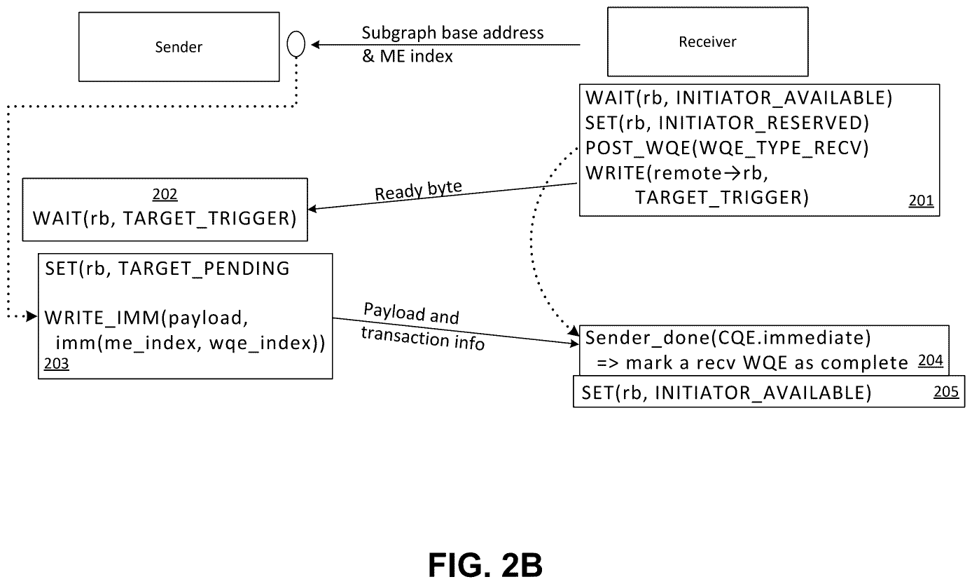

FIG. 2A may illustrate an example method 200. The FIG. 2B may be viewed in concert with the description of FIG. 2A. The method 200 may describe the semantics of the WQEs that the library may create. The method 200 may describe the functions and processes of a CPU (CPU 104) during execution (e.g., transmission of data). For every collective (e.g., set of communication that may occur between one or more sender and receivers simultaneously), a collective operation (e.g., set of data manipulations or data exchanges over structured communication) may be implemented, such as, all-to-all, all-reduce, reduce-scatter, all-gather, broadcast, scatter, gather, barrier, or simple point-to-point data exchange. To enable collective operation(s) the library may create the local base table to describe the target addresses for the data. The entries to the local base table may be initialized on the receiver side (e.g., device 102) of the communication and may be communicated to the sender as part of the method 200.

The method 200 may include creating one or more WQEs to describe the execution of the collective to the MEs. The WQEs may be grouped into subgraphs and work packets. The work packets may be copied and stored into a device memory (e.g., a data store). The libraries may indicate when the WQEs may be executed by the CPU (e.g., CPU 104). The CPU 104 may schedule the WQEs based on the rules defined herein.

The libraries generated WQE may be executed on different devices, the sender (e.g., device 101) or receiver (e.g., device 102) may be scheduled first. However, for simplicity the method 200 may describe execution associated with the receiver's WQE being scheduled first. It is contemplated that while this example method 200 may describe one communication step, in many scenarios, both sides (e.g., sender and receiver) may be in communication as the method is performed.

At step 201, the receiver (e.g., device 102) may receive a ready byte update, via a sender, corresponding to a local ready byte table entry. The ready byte update may comprise a transfer context associated with a local ready byte table. The transfer context may comprise a target address which may be transmitted by the receiver to the sender. The target address may be a location (e.g., local ready byte table entry) associated with the local ready bytes table, associated with the receiver, that may be available to receive data from the sender. The transfer context may comprise information associated with a ready byte. The receiver may wait for the ready byte to become available. The ready byte received may indicate that the transfer context is available. The ready byte table entry may be the same for both the sender (e.g., device 101) and the receiver, however, the ready byte may be selected to avoid aliasing. Aliasing may refer to a process of mapping two or more virtual addresses (e.g., device addresses) to a single memory location. The ready byte index table entry may be derived from a unique tuple of runtime parameters, such as, but not limited to QP number, a library transfer protocol sequence number associated with the QP, or the like. As a result, the receiver may post (e.g., transmit) a receive WQE to notify the sender that the data has been stored in a memory (e.g., data store).

In an example, where the ready byte value does not indicate that the sender is available, the ready byte may indicate that a previous communication step is not done. As a result, the method 200 may exit a WAIT loop, and the ready byte entry may be reserved by setting the address to indicate it is reserved.

At step 202, the receiver may initiate the RDMA write to the target base table of the sender. The RDMA write to the target base table may indicate to the sender that the receiver is ready to receive data. The receiver is indicated to be ready to receive data in response to the RDMA writing a ready byte to the target base table. In some examples, the sender may already have access to the base address of the target (e.g., receiver) buffer.

At step 203, the sender may wait for the ready byte corresponding to the matching receive WQE to be set to ready. In response to the ready byte being sent, the sender may reset the ready byte received to a pending status to prepare for the next transaction (e.g., pending a new RDMA write from the receiver). As a result, the CPU (e.g., CPU 104) may load the target address from the target base table, add the library provided offset associated with the WQE and insert it into the RDMA write with immediate WQE before applying it to the QP's send queue.

At step 204, the receiver may generate a completion queue entry (CQE), in response to the completion of the incoming write with immediate. The CQE may match previously posted receive WQEs. The sender may include some additional data in the messages immediate data field to help the receiver CPU (e.g., CPU 104) determine which receive WQE was completed.

At step 205, receiving a SET WQE setting the ready byte to available. In some examples, to keep the sender and receiver synchronized with respect to ready byte usage, a transaction sequence number may be tracker per QP on both sides (e.g., sender and receiver) within a library or ready byte index. The mapping of the ready byte table entry may be a function of the used QP index and the transaction sequence number.

Although FIG. 2A and FIG. 2B shows example steps of method 200, in some implementations, method 200 may include additional steps, fewer steps, different steps, or differently arranged steps than those depicted in FIG. 2A or FIG. 2B. Additionally, or alternatively, two or more of the steps of method may be performed in parallel.

The transmitting information process may include work request operation elements (e.g., work queue elements (WQEs)) that is based on Remote Direct Memory Access (RDMA). The system may support multiple parallel communications and may run the multiple communication processes over the same Queue Pair (QP). The system may remove the “Receiver Not Ready Negative Acknowledgment” (RNR NAK) messages by preventing the transmission of data until the receiver may be ready (e.g., asynchronous communication). The system may be established in an RDMA over a Converged Ethernet (RoCE) environment and could be implemented on a microprocessor that is dedicated to Intelligent Artificial (AI) Computation. The disclosed subject matter may address when QP scaling may be bottleneck, such as for an approach to handle new communicators by assigning additional QP for handling communication.

FIG. 3 illustrates a block diagram of an example hardware/software architecture of user equipment (UE) 30. As shown in FIG. 3, the UE 30 (also referred to herein as node 30) may include a processor 32, non-removable memory 44, removable memory 46, a speaker/microphone 38, a keypad 40, a display, touchpad, and/or indicators 42, a power source 48, a global positioning system (GPS) chipset 50, and other peripherals 52. The UE 30 may also include a camera 54. In an example, the camera 54 is a smart camera configured to sense images appearing within one or more bounding boxes. The UE 30 may also include communication circuitry, such as a transceiver 34 and a transmit/receive element 36. It will be appreciated that the UE 30 may include any sub-combination of the foregoing elements while remaining consistent with an example.

The processor 32 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., memory 44 and/or memory 46) of the node 30 in order to perform the various required functions of the node. For example, the processor 32 may perform signal coding, data processing, power control, input/output processing, and/or any other functionality that enables the node 30 to operate in a wireless or wired environment. The processor 32 may run application-layer programs (e.g., browsers) and/or radio access-layer (RAN) programs and/or other communications programs. The processor 32 may also perform security operations such as authentication, security key agreement, and/or cryptographic operations, such as at the access-layer and/or application layer for example.

The processor 32 is coupled to its communication circuitry (e.g., transceiver 34 and transmit/receive element 36). The processor 32, through the execution of computer executable instructions, may control the communication circuitry in order to cause the node 30 to communicate with other nodes via the network to which it is connected.

The transmit/receive element 36 may be configured to transmit signals to, or receive signals from, other nodes or networking equipment. For example, in an example, the transmit/receive element 36 may be an antenna configured to transmit and/or receive radio frequency (RF) signals. The transmit/receive element 36 may support various networks and air interfaces, such as wireless local area network (WLAN), wireless personal area network (WPAN), cellular, and the like. In yet another example, the transmit/receive element 36 may be configured to transmit and receive both RF and light signals. It will be appreciated that the transmit/receive element 36 may be configured to transmit and/or receive any combination of wireless or wired signals.

The transceiver 34 may be configured to modulate the signals that are to be transmitted by the transmit/receive element 36 and to demodulate the signals that are received by the transmit/receive element 36. As noted above, the node 30 may have multi-mode capabilities. Thus, the transceiver 34 may include multiple transceivers for enabling the node 30 to communicate via multiple radio access technologies (RATs), such as universal terrestrial radio access (UTRA) and Institute of Electrical and Electronics Engineers (IEEE 802.11), for example.

The processor 32 may access information from, and store data in, any type of suitable memory, such as the non-removable memory 44 and/or the removable memory 46. For example, the processor 32 may store session context in its memory, as described above. The non-removable memory 44 may include RAM, ROM, a hard disk, or any other type of memory storage device. The removable memory 46 may include a subscriber identity module (SIM) card, a memory stick, a secure digital (SD) memory card, and the like. In other examples, the processor 32 may access information from, and store data in, memory that is not physically located on the node 30, such as on a server or a home computer.

The processor 32 may receive power from the power source 48 and may be configured to distribute and/or control the power to the other components in the node 30. The power source 48 may be any suitable device for powering the node 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 32 may also be coupled to the GPS chipset 50, which may be configured to provide location information (e.g., longitude and latitude) regarding the current location of the node 30. It will be appreciated that the node 30 may acquire location information by way of any suitable location-determination method while remaining consistent with an example.

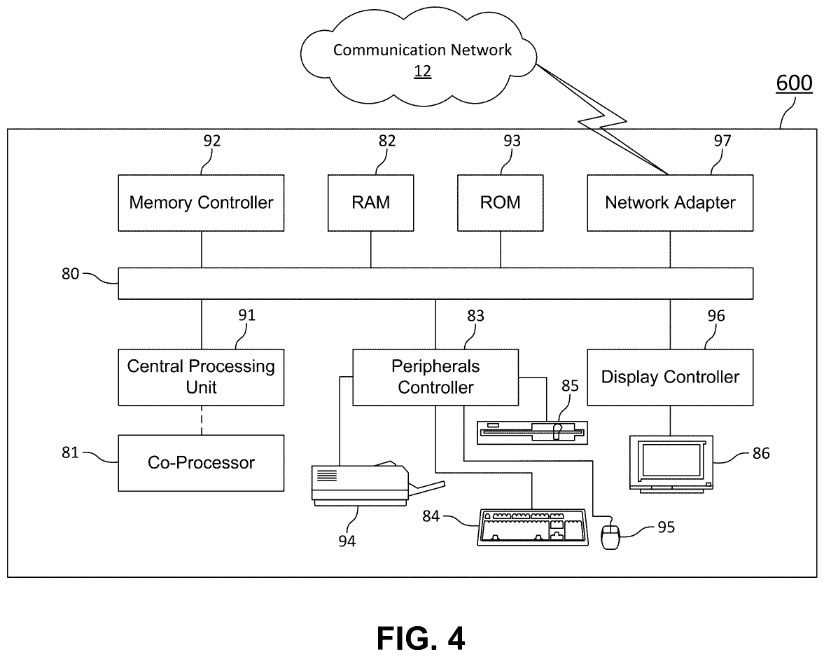

FIG. 4 is a block diagram of an exemplary computing system 500. In some exemplary embodiments, the network device 110 may be a computing system 500. The computing system 500 may comprise a computer or server and may be controlled primarily by computer readable instructions, which may be in the form of software, wherever, or by whatever means such software is stored or accessed. Such computer readable instructions may be executed within a processor, such as central processing unit (CPU) 91, to cause computing system 300 to operate. In many workstations, servers, and personal computers, central processing unit 91 may be implemented by a single-chip CPU called a microprocessor. In other machines, the central processing unit 91 may comprise multiple processors. Coprocessor 81 may be an optional processor, distinct from main CPU 91, that performs additional functions or assists CPU 91.

In operation, CPU 91 fetches, decodes, and executes instructions, and transfers information to and from other resources via the computer's main data-transfer path, system bus 80. Such a system bus connects the components in computing system 500 and defines the medium for data exchange. System bus 80 typically includes data lines for sending data, address lines for sending addresses, and control lines for sending interrupts and for operating the system bus. An example of such a system bus 80 is the Peripheral Component Interconnect (PCI) bus.

Memories coupled to system bus 80 include RAM 82 and ROM 93. Such memories may include circuitry that allows information to be stored and retrieved. ROMs 93 generally contain stored data that cannot easily be modified. Data stored in RAM 82 may be read or changed by CPU 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 500 may contain peripherals controller 83 responsible for communicating instructions from CPU 91 to peripherals, such as printer 94, keyboard 84, mouse 95, and disk drive 85.

Display 86, which is controlled by display controller 96, is used to display visual output generated by computing system 500. Such visual output may include text, graphics, animated graphics, and video. Display 86 may be implemented with a cathode-ray tube (CRT)-based video display, a liquid-crystal display (LCD)-based flat-panel display, gas plasma-based flat-panel display, or a touch-panel. Display controller 96 includes electronic components required to generate a video signal that is sent to display 86.

Further, computing system 500 may contain communication circuitry, such as for example a network adaptor 97, that may be used to connect computing system 500 to an external communications network, such as network 12 of FIG. 3, to enable the computing system 500 to communicate with other nodes (e.g., UE 30) of the network.

It is to be appreciated that examples of the methods and apparatuses described herein are not limited in application to the details of construction and the arrangement of components set forth in the following description or illustrated in the accompanying drawings. The methods and apparatuses are capable of implementation in other examples and of being practiced or of being carried out in various ways. Examples of specific implementations are provided herein for illustrative purposes only and are not intended to be limiting. In particular, acts, elements and features described in connection with any one or more examples are not intended to be excluded from a similar role in any other examples.

It is to be understood that the methods and systems described herein are not limited to specific methods, specific components, or to particular implementations. It is also to be understood that the terminology used herein is for the purpose of describing particular examples only and is not intended to be limiting.

Some portions of this description describe the embodiments in terms of applications and symbolic representations of operations on information. These application descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as components, without loss of generality. The described operations and their associated components may be embodied in software, firmware, hardware, or any combinations thereof.

Any of the steps, operations, or processes described herein may be performed or implemented with one or more hardware or software components, alone or in combination with other devices. In one embodiment, a software component is implemented with a computer program product comprising a computer-readable medium containing computer program code, which can be executed by a computer processor for performing any or all of the steps, operations, or processes described.

Embodiments also may relate to an apparatus for performing the operations herein. This apparatus may be specially constructed for the required purposes, and/or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

As used herein, the terms “data,” “content,” “information” and similar terms may be used interchangeably to refer to data capable of being transmitted, received and/or stored in accordance with examples of the disclosure. Moreover, the term “exemplary”, as used herein, is not provided to convey any qualitative assessment, but instead merely to convey an illustration of an example. Thus, use of any such terms should not be taken to limit the spirit and scope of examples of the disclosure.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein, an “application” may refer to a computer software package that may perform specific functions for users and/or, in some cases, for another application(s). An application(s) may utilize an operating system (OS) and other supporting programs to function. In some examples, an application(s) may request one or more services from, and communicate with, other entities via an application programming interface (API).

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The foregoing description of the examples has been presented for the purpose of illustration; it is not intended to be exhaustive or to limit the patent rights to the precise forms disclosed. Persons skilled in the relevant art can appreciate that many modifications and variations are possible in light of the disclosure.

The scope of this disclosure encompasses all changes, substitutions, variations, alterations, and modifications to the example examples described or illustrated herein that a person having ordinary skill in the art would comprehend. The scope of this disclosure is not limited to the example examples described or illustrated herein. Moreover, although this disclosure describes and illustrates respective examples herein as including particular components, elements, feature, functions, operations, or steps, any of these examples may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular examples as providing particular advantages, particular examples may provide none, some, or all of these advantages.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the examples is intended to be illustrative, but not limiting, of the scope of the patent rights, which is set forth in the following claims.

### B. Systems and Methods for Generating Super-Resolution of UV Textures for Digital Humans

### Background

Currently, rendering high-quality and photorealistic images of digital humans requires high-resolution UV texture maps created by technical artists. To increase photorealism and diversity of digital humans, recent tools have been developed to assist artists in leveraging generative AI and/or making edits programmatically.

Although artists now have tools that can use machine learning (ML) methods, such as text-to-image generation, to increase photorealism and diversity, such methods do not scale well and typically work in the rendered image space rather than UV texture space. Furthermore, these methods rely on integration with rendering engines and therefore have limited applications. Many data-driven and scalable ML and statistical methods (e.g., principal component analysis (PCA)) may be used to improve photorealism, diversity, and controllability of edits; however, these methods require a much lower image resolution than necessary for rendering (e.g., 512×512 vs. 4 k×4 k). There is thus a need for a scalable, high-resolution rendering systems for UV textures.

### Summary

A novel architecture and method are described in one or more aspects of the subject application that enables super-resolution of UV textures, such as for digital humans. The method may enhance the detail and image resolution of UV texture maps. The method may use a generative adversarial framework where the upsampling network is trained to enhance the image resolution through feedback from a discriminator network. This may result in an improvement in realism, diversity, and controllability of UV textures for rendering digital humans.

The subject application is at least directed to methods and systems for generating super-resolution images for UV textures of digital humans. In one aspect, a system may include: a non-transitory memory with instructions stored thereon; and a processor operably coupled to the non-transitory memory and configured to execute the instructions of: receiving, by a trained upsampling model, a low-resolution UV texture image; generating, by the trained upsampling model, a high-resolution UV texture image based on the low-resolution UV texture image, wherein the generating comprises upsampling the low-resolution UV texture image according to one or more identified features of the low-resolution UV texture image; and storing the high-resolution UV texture image.

### Detailed Description

Some examples of the subject technology will now be described more fully hereinafter with reference to the accompanying drawings, in which some, but not all examples of the subject technology are shown. Indeed, various examples of the subject technology may be embodied in many different forms and should not be construed as limited to the examples set forth herein. Like reference numerals refer to like elements throughout.

As used herein, the terms “data,” “content,” “information,” and similar terms may be used interchangeably to refer to data capable of being transmitted, received and/or stored in accordance with examples of the disclosure. Moreover, the term “exemplary,” as used herein, is not provided to convey any qualitative assessment, but instead merely to convey an illustration of an example. Thus, use of any such terms should not be taken to limit the spirit and scope of examples of the disclosure.

As defined herein, a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein, an “application” may refer to a computer software package that may perform specific functions for users and/or, in some cases, for another application(s). An application(s) may utilize an operating system (OS) and other supporting programs to function. In some examples, an application(s) may request one or more services from, and communicate with, other entities via an application programming interface (API).

As referred to herein, a Metaverse may denote an immersive virtual space or world in which devices may be utilized in a network in which there may, but need not, be one or more social connections among users in the network or with an environment in the virtual space or world. A Metaverse or Metaverse network may be associated with three-dimensional (3D) virtual worlds, online games (e.g., video games), one or more content items such as, for example, images, videos, non-fungible tokens (NFTs) and in which the content items may, for example, be purchased with digital currencies (e.g., cryptocurrencies) and other suitable currencies. In some examples, a Metaverse or Metaverse network may enable the generation and provision of immersive virtual spaces in which remote users may socialize, collaborate, learn, shop and/or engage in various other activities within the virtual spaces, including through the use of augmented/virtual/mixed reality.

As referred to herein, a resource(s), or an external resource(s) may refer to any entity or source that may be accessed by a program or system that may be running, executed or implemented on a communication device and/or a network. Some examples of resources may include, but are not limited to, HyperText Markup Language (HTML) pages, web pages, images, videos, scripts, stylesheets, other types of files (e.g., multimedia files) that may be accessible via a network (e.g., the Internet) as well as other files that may be locally stored and/or accessed by communication devices.

It is to be understood that the methods and systems described herein are not limited to specific methods, specific components, or to particular implementations. It is also to be understood that the terminology used herein is for the purpose of describing particular embodiments only and is not intended to be limiting.

### Exemplary System Architecture

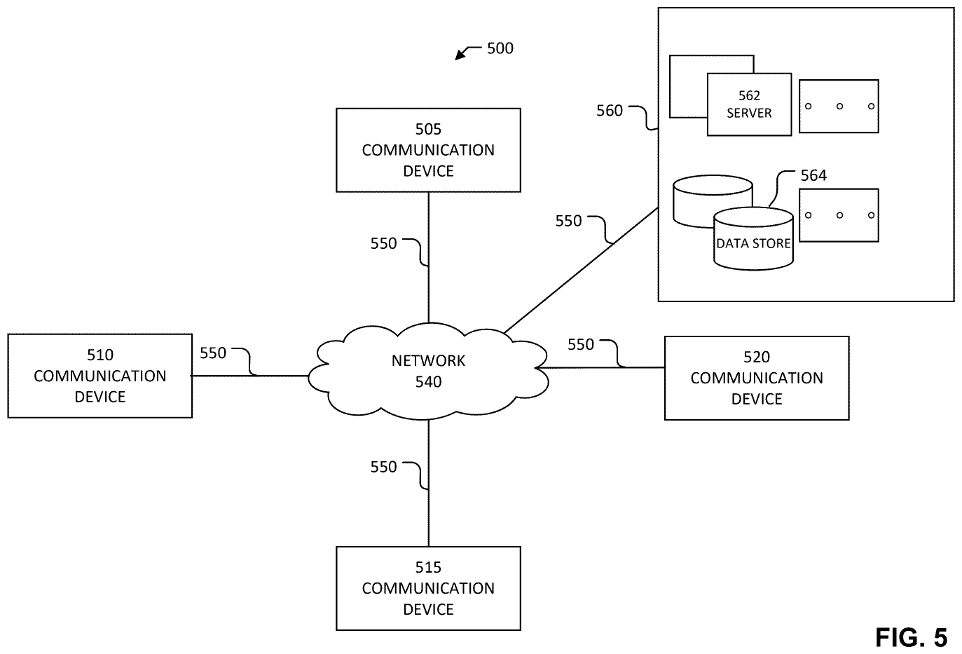

Reference is now made to FIG. 5, which is a block diagram of a system according to exemplary embodiments. As shown in FIG. 5, the system 500 may include one or more communication devices 505, 510, 515 and 520 and a network device 560. Additionally, the system 500 may include any suitable network such as, for example, network 540. In some examples, the network 540. In other examples, the network 540 may be any suitable network capable of provisioning content and/or facilitating communications among entities within, or associated with the network 540. As an example and not by way of limitation, one or more portions of network 540 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 540 may include one or more networks 540.

Links 550 may connect the communication devices 505, 510, 515 and 520 to network 540, network device 560 and/or to each other. This disclosure contemplates any suitable links 550. In some exemplary embodiments, one or more links 550 may include one or more wired and/or wireless links, such as, for example, Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH). In some exemplary embodiments, one or more links 550 may each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 550, or a combination of two or more such links 550. Links 550 need not necessarily be the same throughout system 500. One or more first links 550 may differ in one or more respects from one or more second links 550.

In some exemplary embodiments, communication devices 505, 510, 515, 520 may be electronic devices including hardware, software, or embedded logic components or a combination of two or more such components and capable of carrying out the appropriate functionalities implemented or supported by the communication devices 505, 510, 515, 520. As an example, and not by way of limitation, the communication devices 505, 510, 515, 520 may be a computer system such as, for example, a desktop computer, notebook or laptop computer, netbook, a tablet computer (e.g., a smart tablet), e-book reader, Global Positioning System (GPS) device, camera, personal digital assistant (PDA), handheld electronic device, cellular telephone, smartphone, smart glasses, augmented/virtual reality device, smart watches, charging case, or any other suitable electronic device, or any suitable combination thereof. The communication devices 505, 510, 515, 520 may enable one or more users to access network 540. The communication devices 505, 510, 515, 520 may enable a user(s) to communicate with other users at other communication devices 505, 510, 515, 520.

Network device 560 may be accessed by the other components of system 500 either directly or via network 540. As an example and not by way of limitation, communication devices 505, 510, 515, 520 may access network device 560 using a web browser or a native application associated with network device 560 (e.g., a mobile social-networking application, a messaging application, another suitable application, or any combination thereof) either directly or via network 540. In particular exemplary embodiments, network device 560 may include one or more servers 562. Each server 562 may be a unitary server or a distributed server spanning multiple computers or multiple datacenters. Servers 562 may be of various types, such as, for example and without limitation, web server, news server, mail server, message server, advertising server, file server, application server, exchange server, database server, proxy server, another server suitable for performing functions or processes described herein, or any combination thereof. In particular exemplary embodiments, each server 562 may include hardware, software, or embedded logic components or a combination of two or more such components for carrying out the appropriate functionalities implemented and/or supported by server 562. In particular exemplary embodiments, network device 560 may include one or more data stores 564. Data stores 564 may be used to store various types of information. In particular exemplary embodiments, the information stored in data stores 564 may be organized according to specific data structures. In particular exemplary embodiments, each data store 564 may be a relational, columnar, correlation, or other suitable database. Although this disclosure describes or illustrates particular types of databases, this disclosure contemplates any suitable types of databases. Particular exemplary embodiments may provide interfaces that enable communication devices 505, 510, 515, 520 and/or another system (e.g., a third-party system) to manage, retrieve, modify, add, or delete, the information stored in data store 564.

Network device 560 may provide users of the system 500 the ability to communicate and interact with other users. In particular exemplary embodiments, network device 560 may provide users with the ability to take actions on various types of items or objects, supported by network device 560. In particular exemplary embodiments, network device 560 may be capable of linking a variety of entities. As an example and not by way of limitation, network device 560 may enable users to interact with each other as well as receive content from other systems (e.g., third-party systems) or other entities, or allow users to interact with these entities through an application programming interfaces (API) or other communication channels.

It should be pointed out that although FIG. 5 shows one network device 560 and four communication devices 505, 510, 515 and 520, any suitable number of network devices 560 and communication devices 505, 510, 515 and 520 may be part of the system of FIG. 5 without departing from the spirit and scope of the present disclosure.

### Exemplary Communication Device

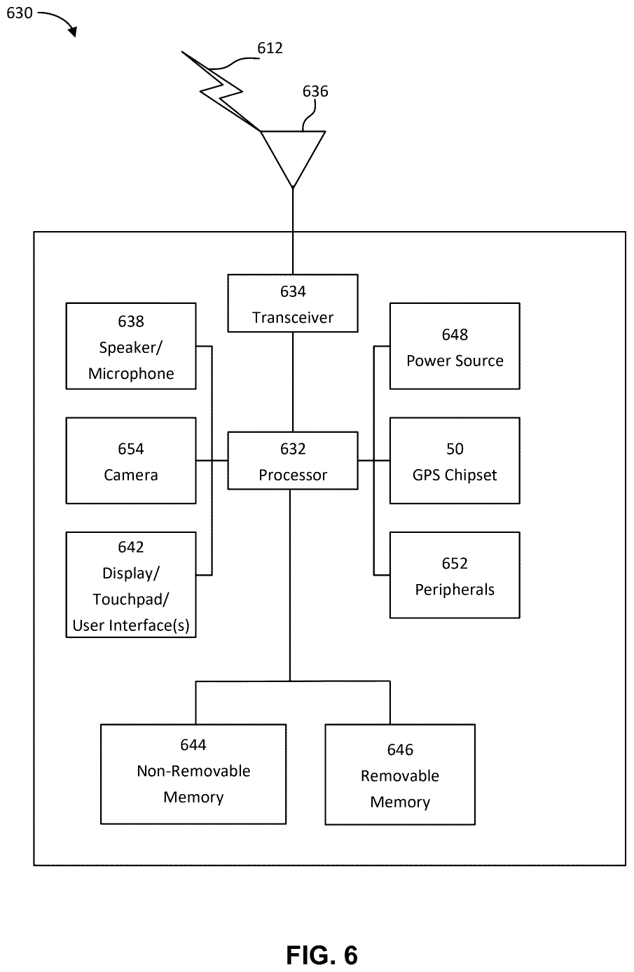

FIG. 6 illustrates a block diagram of an exemplary hardware/software architecture of a communication device such as, for example, user equipment (UE) 630. In some exemplary respects, the UE 630 may be any of communication devices 505, 510, 515, 520. In some exemplary aspects, the UE 630 may be a computer system such as, for example, a desktop computer, notebook or laptop computer, netbook, a tablet computer (e.g., a smart tablet), e-book reader, GPS device, camera, personal digital assistant, handheld electronic device, cellular telephone, smartphone, smart glasses, augmented/virtual reality device, smart watch, charging case, or any other suitable electronic device. As shown in FIG. 6, the UE 630 (also referred to herein as node 630) may include a processor 632, non-removable memory 644, removable memory 646, a speaker/microphone 638, a display, touchpad, and/or user interface(s) 642, a power source 648, a GPS chipset 650, and other peripherals 652. In some exemplary aspects, the display, touchpad, and/or user interface(s) 642 may be referred to herein as display/touchpad/user interface(s) 642. The display/touchpad/user interface(s) 642 may include a user interface capable of presenting one or more content items and/or capturing input of one or more user interactions/actions associated with the user interface. The power source 648 may be capable of receiving electric power for supplying electric power to the UE 630. For example, the power source 648 may include an alternating current to direct current (AC-to-DC) converter allowing the power source 648 to be connected/plugged to an AC electrical receptacle and/or Universal Serial Bus (USB) port for receiving electric power. The UE 630 may also include a camera 654. In an exemplary embodiment, the camera 654 may be a smart camera configured to sense images/video appearing within one or more bounding boxes. The UE 630 may also include communication circuitry, such as a transceiver 634 and a transmit/receive element 636. It will be appreciated the UE 630 may include any sub-combination of the foregoing elements while remaining consistent with an embodiment.

The processor 632 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 632 may execute computer-executable instructions stored in the memory (e.g., non-removable memory 644 and/or removable memory 646) of the node 630 in order to perform the various required functions of the node. For example, the processor 632 may perform signal coding, data processing, power control, input/output processing, and/or any other functionality that enables the node 630 to operate in a wireless or wired environment. The processor 632 may run application-layer programs (e.g., browsers) and/or radio access-layer (RAN) programs and/or other communications programs. The processor 632 may also perform security operations such as authentication, security key agreement, and/or cryptographic operations, such as at the access-layer and/or application layer for example. The non-removable memory 644 and/or the removable memory 646 may be computer-readable storage mediums. For example, the non-removable memory 644 may include a non-transitory computer-readable storage medium and a transitory computer-readable storage medium.

The processor 632 is coupled to its communication circuitry (e.g., transceiver 634 and transmit/receive element 636). The processor 632, through the execution of computer-executable instructions, may control the communication circuitry in order to cause the node 630 to communicate with other nodes via the network to which it is connected.

The transmit/receive element 636 may be configured to transmit signals to, or receive signals from, other nodes or networking equipment. For example, in an exemplary embodiment, the transmit/receive element 636 may be an antenna configured to transmit and/or receive radio frequency (RF) signals. The transmit/receive element 636 may support various networks and air interfaces, such as wireless local area network (WLAN), wireless personal area network (WPAN), cellular, and the like. In yet another exemplary embodiment, the transmit/receive element 636 may be configured to transmit and/or receive both RF and light signals. It will be appreciated that the transmit/receive element 636 may be configured to transmit and/or receive any combination of wireless or wired signals.

The transceiver 634 may be configured to modulate the signals that are to be transmitted by the transmit/receive element 636 and to demodulate the signals that are received by the transmit/receive element 636. As noted above, the node 630 may have multi-mode capabilities. Thus, the transceiver 634 may include multiple transceivers for enabling the node 630 to communicate via multiple radio access technologies (RATs), such as universal terrestrial radio access (UTRA) and Institute of Electrical and Electronics Engineers (IEEE 802.11), for example.

The processor 632 may access information from, and store data in, any type of suitable memory, such as the non-removable memory 644 and/or the removable memory 646. For example, the processor 632 may store session context in its memory, (e.g., non-removable memory 644 and/or removable memory 646) as described above. The non-removable memory 644 may include RAM, ROM, a hard disk, or any other type of memory storage device. The removable memory 646 may include a subscriber identity module (SIM) card, a memory stick, a secure digital (SD) memory card, and the like. In other exemplary embodiments, the processor 632 may access information from, and store data in, memory that is not physically located on the node 630, such as on a server or a home computer.

The processor 632 may receive power from the power source 648 and may be configured to distribute and/or control the power to the other components in the node 630. The power source 648 may be any suitable device for powering the node 630. For example, the power source 648 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like. The processor 632 may also be coupled to the GPS chipset 650, which may be configured to provide location information (e.g., longitude and latitude) regarding the current location of the node 630. It will be appreciated that the node 630 may acquire location information by way of any suitable location-determination method while remaining consistent with an exemplary embodiment.

### Exemplary Computing System

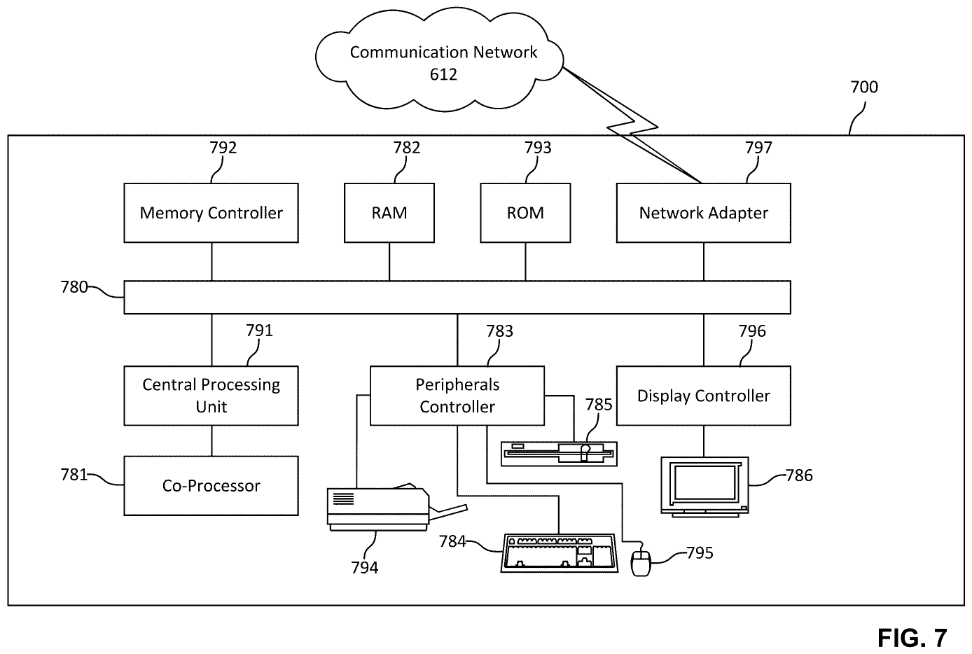

FIG. 7 is a block diagram of an exemplary computing system 700. In some exemplary embodiments, the network device 560 may be a computing system 700. The computing system 700 may comprise a computer or server and may be controlled primarily by computer-readable instructions, which may be in the form of software, wherever, or by whatever means such software is stored or accessed. Such computer-readable instructions may be executed within a processor, such as central processing unit (CPU) 791, to cause computing system 700 to operate. In many workstations, servers, and personal computers, central processing unit 791 may be implemented by a single-chip CPU called a microprocessor. In other machines, the central processing unit 791 may comprise multiple processors. Coprocessor 81 may be an optional processor, distinct from main CPU 791, that performs additional functions or assists CPU 791.

In operation, CPU 791 fetches, decodes, and executes instructions, and transfers information to and from other resources via the computer's main data-transfer path, system bus 780. Such a system bus connects the components in computing system 700 and defines the medium for data exchange. System bus 780 typically includes data lines for sending data, address lines for sending addresses, and control lines for sending interrupts and for operating the system bus. An example of such a system bus 780 is the Peripheral Component Interconnect (PCI) bus.

Memories coupled to system bus 780 include RAM 782 and ROM 793. Such memories may include circuitry that allows information to be stored and retrieved. ROMs 793 generally contain stored data that cannot easily be modified. Data stored in RAM 782 may be read or changed by CPU 791 or other hardware devices. Access to RAM 782 and/or ROM 793 may be controlled by memory controller 792. Memory controller 792 may provide an address translation function that translates virtual addresses into physical addresses as instructions are executed. Memory controller 792 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 700 may contain peripherals controller 783 responsible for communicating instructions from CPU 791 to peripherals, such as printer 794, keyboard 784, mouse 795, and disk drive 785.

Display 786, which is controlled by display controller 796, may be used to display visual output generated by computing system 700. Such visual output may include text, graphics, animated graphics, and video. The display 786 may also include or be associated with a user interface. The user interface may be capable of presenting one or more content items and/or capturing input of one or more user interactions associated with the user interface. Display 786 may be implemented with a cathode-ray tube (CRT)-based video display, a liquid-crystal display (LCD)-based flat-panel display, gas plasma-based flat-panel display, or a touch-panel. Display controller 796 includes electronic components required to generate a video signal that is sent to display 786.

Further, computing system 700 may contain communication circuitry, such as for example a network adapter 797, that may be used to connect computing system 300 to an external communications network, such as network 612 of FIG. 6, to enable the computing system 700 to communicate with other nodes (e.g., UE 630) of the network.

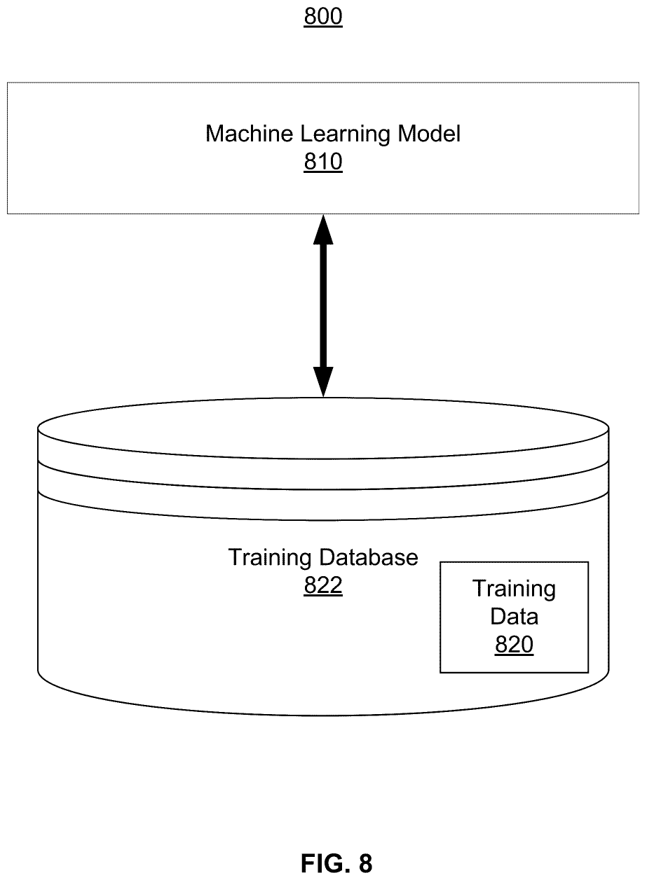

FIG. 8 illustrates a machine learning (ML) and training model, in accordance with an example of the present disclosure. The machine learning framework 800 associated with the machine learning model may be hosted remotely. Alternatively, the machine learning framework 800 may reside within a server 562 shown in FIG. 5, or be processed by an electronic device (e.g., head mounted displays, smartphones, tablets, smartwatches, or any electronic device, such as communication device 505). The machine learning model 810 may be communicatively coupled to the stored training data 820 in a memory or database (e.g., ROM, RAM) such as training database 822. In some examples, the machine learning model 810 may be associated with operations of any one or more of the systems/architectures depicted in subsequent figures of the application. In some other examples, the machine learning model 810 may be associated with other operations. The machine learning model 810 may be implemented by one or more machine learning models(s) and/or another device (e.g., a server and/or a computing system). In some embodiments, the machine learning model 810 may be a student model trained by a teacher model, and the teacher model may be included in the training database 822.

### Super-Resolution of UV Textures

According to an aspect of the instant application, a method is disclosed that enables super-resolution of UV textures, such as for digital humans. During training, existing high-resolution UV texture maps may be downsampled and fed into the upsampling network in order to predict the original high-resolution textures. Different from other super-resolution methods, the discriminator network of the instant application may compare high-dimensional features extracted from a pre-trained image classification network, which may improve the training stability and perceptual quality. Once trained, the discriminator network may be suspended and the upsampling network may be used to enhance image resolution of unseen UV texture maps for the rendering pipeline.

According to an aspect of the instant application, the system and methods described herein may enhance fine details and image resolution of UV texture maps. ML techniques described herein may generate diverse textures at scale, which may save time and resources for increasing diversity among textures for rendering photorealistic digital humans. This approach may allow for ML techniques and data-driven methods that are typically not supported when using generative AI tools in rendering engine software.

The current PCA implementation for textures are limited in handling a maximum of 1 k resolution. In order to match the high image resolutions expected for high-fidelity Digital Humans, an ML-based super-resolution technique may be implemented to upsample from 1 k to 4 k resolution. According to an aspect of the instant application, models may be trained to upsample different portions of a digital human, such as faces and hand/body textures.

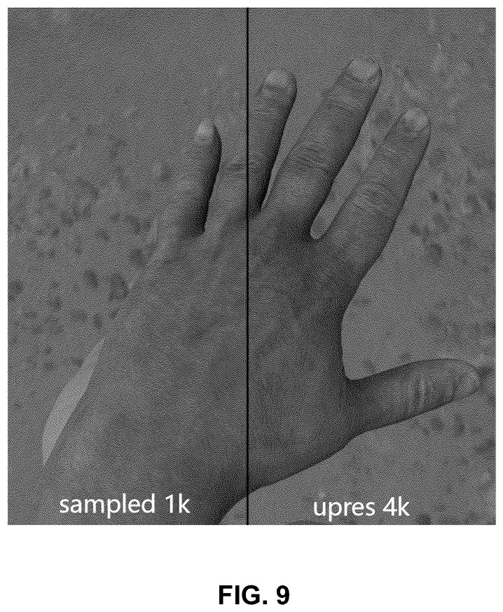

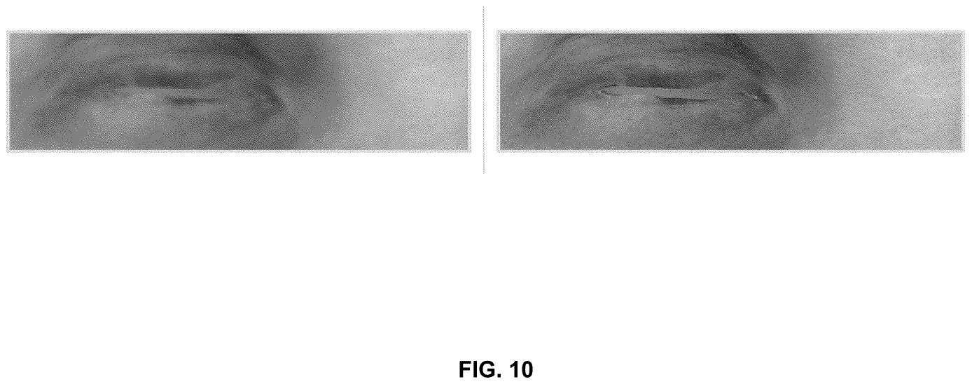

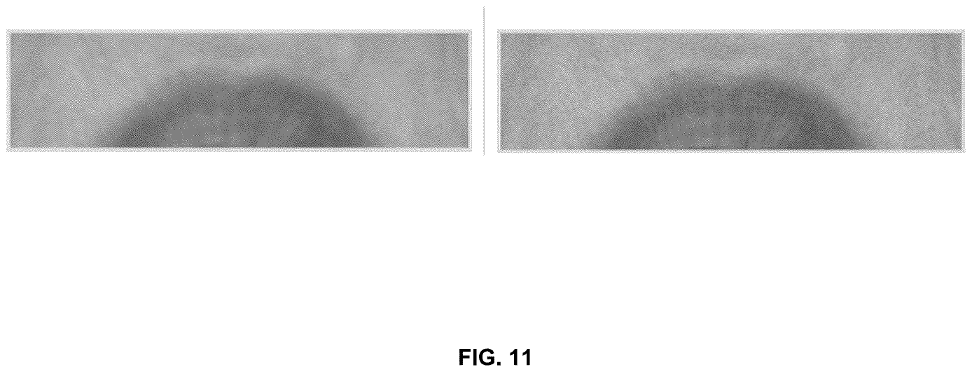

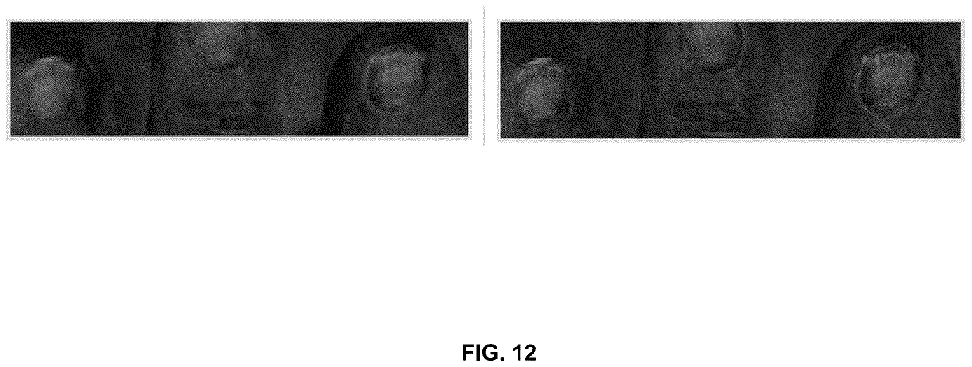

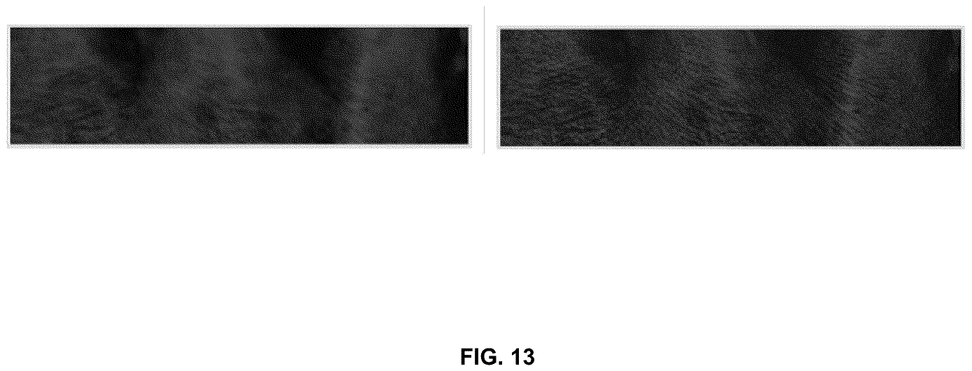

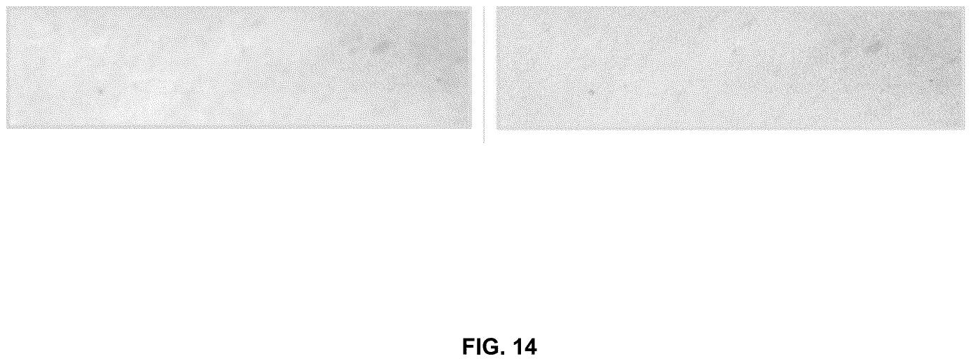

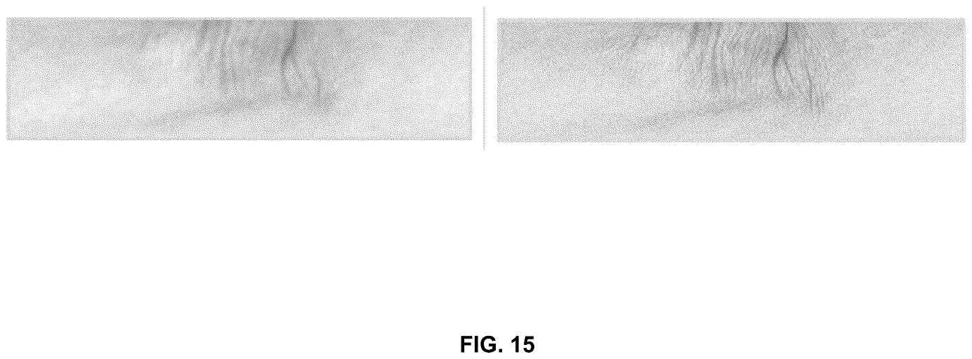

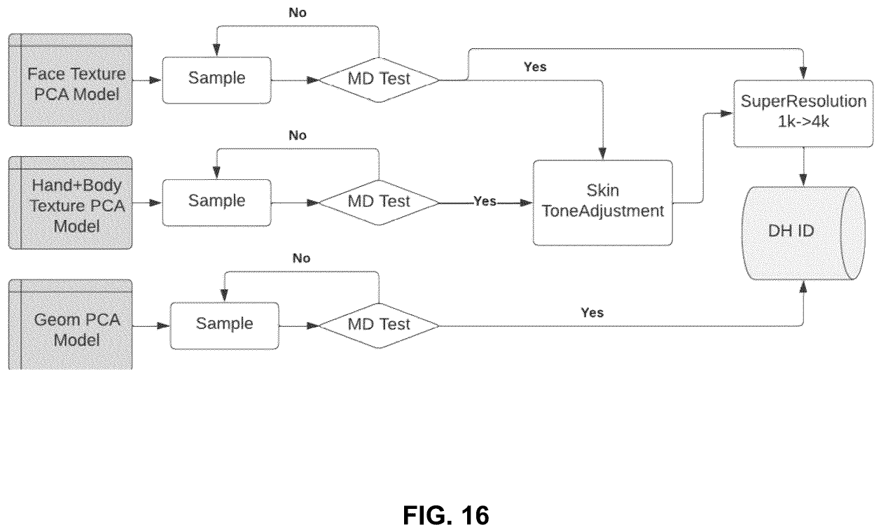

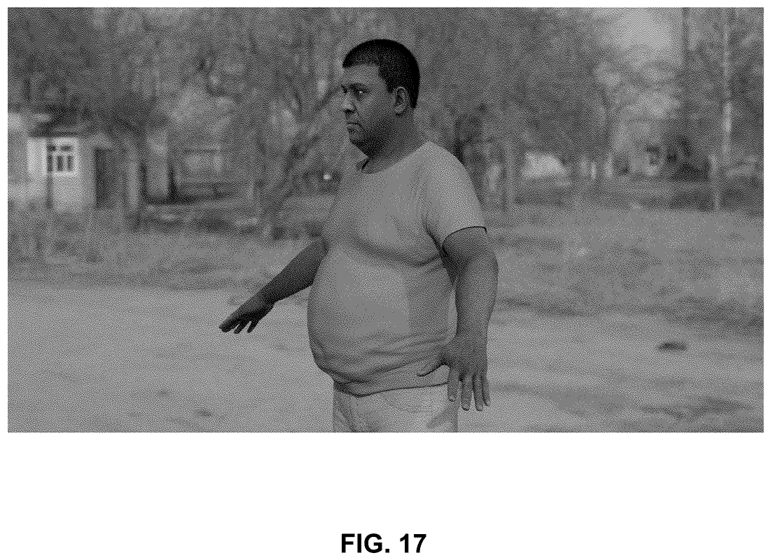

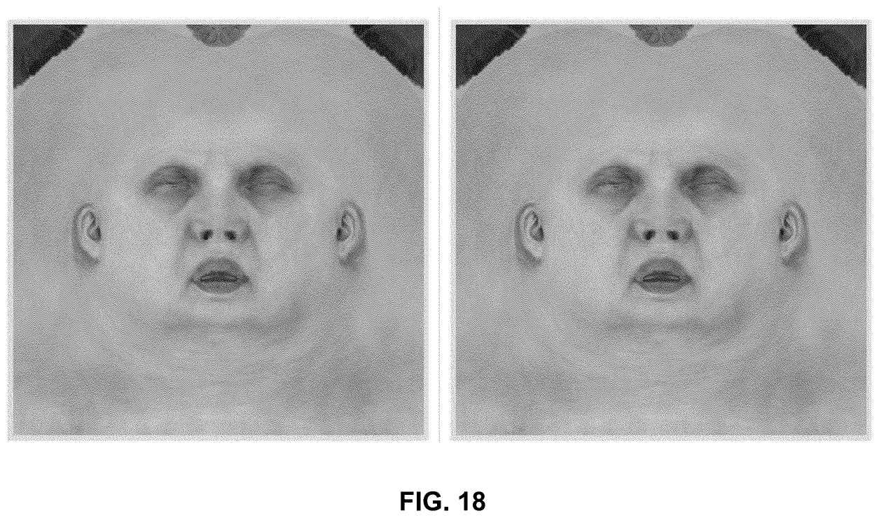

According to the instant application, FIG. 9 illustrates a rendered image of a hand sampled 1 k resolution (left), and of a 4 k super resolution of the hand (right). FIG. 10 illustrates UV textured images of an eye in a sampled 1 k resolution (left), and a 4 k super resolution of the eye (right), in accordance with example aspects of the present disclosure. FIG. 11 illustrates UV textured images of a lip in a sampled 1 k resolution (left), and a 4 k super resolution of the lip (right), in accordance with example aspects of the present disclosure. FIG. 12 illustrates UV textured images of fingertips in a sampled 1 k resolution (left), and a 4 k super resolution of the fingertips (right), in accordance with example aspects of the present disclosure. FIG. 13 illustrates UV textured images of knuckles in a sampled 1 k resolution (left), and a 4 k super resolution of the knuckles (right), in accordance with example aspects of the present disclosure. FIG. 14 illustrates UV textured images of a shoulder in a sampled 1 k resolution (left), and a 4 k super resolution of the shoulder (right), in accordance with example aspects of the present disclosure. FIG. 15 illustrates UV textured images of a knee in a sampled 1 k resolution (left), and a 4 k super resolution of the knee (right), in accordance with example aspects of the present disclosure. FIG. 16 illustrates a system for UV texture generation in accordance with example aspects of the present disclosure. FIG. 17 illustrates a digital human rendering with UV textures in accordance with example aspects of the present disclosure. FIG. 18 illustrates UV textured images of a face in a sampled 1 k resolution (left), and a 4 k super resolution of the face (right), in accordance with example aspects of the present disclosure.

### Model Training

ML-based super resolution is a technique for enhancing the image resolution of lower-resolution images, typically by upsampling by a factor of 2 or 4. In general, the goal of super-resolution may be to train a model that takes a low-resolution image as input and outputs a high-resolution image.

For datasets that share many of the image features, training may include predicting high-resolution image patches from the downsampled counterparts. However, for more general applications, various image augmentations may be incorporated during training to ensure a more robust model.

For training a super-resolution model, images at the target image resolution (e.g., 4096×4096 images) may act as input. The corresponding low-resolution images may be generated at runtime using resize augmentation. An approach for training may be to store the high-resolution images within a directory (local or manifold path). Other data formats may be supported as well.

According to an example model configuration file, a number of channels for input of low-resolution images (e.g., 3 channels) may be configured, such as the TASK_MODEL.IN_CHANNELS section of the model configuration file. In some cases, a number of channels in the generated image may be configured (e.g., the same number of input channels), such as the TASK_MODEL.OUT_CHANNELS section of the model configuration file. In some cases, a number of upsampling steps (e.g., 2 steps for 512 to 2048 pixels) may be configured, such as the TASK_MODEL.GENERATOR_KWARGS section of the model configuration file.

According to an example data configuration file, data paths may be configured for facilitating super resolution UV texture generation. For example using the “configs/data/superres.yaml” file as a template, data paths may be changed to be directed to the image files. For example, for a [TRAIN/TRAIN_TARGET].DATA_PATH, the path may be to json file or subdirectory containing files to use for training. The same path may be used for both TRAIN/TRAIN_TARGET (these may be sampled as pairs of low and high resolution images).

For the augmentation configuration file, the “augmentations/superres.json” file may be used as a template. The following sections may be changed to match the respective use case: [train/train_target].Random_Crop, which may be a high-resolution image crop size; Train.Resize:size, which may be a low-resolution image size (downsample to match “n_upsample” above); and train.[torchvision transform], which may be optional image augmentations to improve model robustness (e.g., GaussianBlur). Additionally, the “n_upsample” may define the number of upsampling steps the model is to perform, and the TRAIN/TRAIN_TARGET datapaths may point to the same paths, unless low-resolution/augmented input data is created. The low-resolution inputs may be generated at runtime using torchvision transforms, but additional augmentations may be included to improve model robustness for more challenging use cases.

For running inference with a trained super-resolution model, the model may be applied iteratively across multiple tiles. For smaller images (e.g., less than 4 k image resolution), it may be possible to directly apply super-resolution without tiling.

This iterative tiling may be accomplished by using the following: TileInput/TileOutput augmentations and TileDataset/TileLoader dataset and loader. The most straightforward approach may be using the same cropped image size that was used during training and iteratively upsample each tile of the full image. For example, the default configs may assume 4096×4096 target image resolution, which is divided into 4 tiles of 2048×2048 image resolution.

The TileInput class may sample each tile iteratively and the TileDataset/TileLoader serves them across N_TILES iterations, resulting in N_TILES*N_IMAGES total iterations during inference. The TileOutput class may be used as a postprocessing step (defined in the augmentation config file's “postprocess” section) to stitch the various tiles together when writing the images.

If tiling is not necessary for the use case, the “LOADER” field from “VAL_SOURCE” in the data configuration file may be removed. Similarly, the “TileInput” definition in the “val_source” section of the augmentation config file may be removed as well as the “postprocess” section.

As another example, using the “configs/data/superres.yaml” file as a template, the data paths of the template may be changed to point to the respective image files: VAL_SOURCE.DATA_PATH: path to json file or subdirectory containing low-resolution image files; and VAL_SOURCE.LOADER: set to “TileLoader” if applying super-resolution iteratively (otherwise, remove).

As another example, using the “augmentations/superres.json” file as a template, following sections of the template may be changed to match the respective use case (remove if not using tiling approach): val_source.TileInput: img_size: low-resolution image size (int or tuple of height and width); tile_size: low-resolution tile size (int or tuple); blend_size: number of overlapping pixels in low-resolution image to blend tiles; postprocess.TileOutput: img_size: high-resolution image size (int or tuple); tile_size: high-resolution tile size (int or tuple); and blend_size: number of overlapping pixels in high-resolution image to blend tiles.

### C. Path Recovery From Link Failures for Multi-Path Transport in Datacenters

### Technical Field

This application is directed to data transmission through a network, and more particularly, to the transmission of data through a new path after a failed transmission through a prior path.

### Background

Artificial intelligence (AI) training clusters are built using high performance accelerators communicating with each other via a high throughput/low latency network fabric. Depending on topology, nodes in a cluster can communicate over logical paths traversing through physical links. These logical paths maintain current state of transmission of the messages. In case of drops due to network conditions, state of the art transport protocols retransmit messages using supported mechanisms (e.g., go-back-N, selective acknowledgement).

### Brief Summary

Some examples of the present disclosure are directed to devices (e.g., networking devices, end user devices, edge devices, etc.) for communicating data, via optical communication, between computing devices, between servers, and/or between computing devices and servers.

In one example aspect, systems and methods may be provided utilizing multiple physical paths to transmit a data packet(s) from one node to another node. The system may include a communication channel for a first node and a second node. The communication channel may include a first transmit port configured to transmit, via a network fabric, a data packet from the first node to the second node. The first transmit port may define in part a first physical path. The communication channel may include a second transmit port that defines a second physical path different from the first physical path. The communication channel may include a receive port configured to receive, via the network fabric, the data packet. The receive port may include a receive tracker configured to provide an acknowledgement that the data packet is received at the receive port. In response to the acknowledgement not being received within a predetermined time period through the first physical path, the communication channel may be configured to retransmit, via the network fabric, the data packet from the first node to the second node via the second transmit port to the receive port.

A system relies on multiple physical paths to transmit a data packet(s) from one node to another node(s). A logical path may be established through a physical path to transmit the data. When a link failure occurs (e.g., when a state of the transmission indicates a failure), the logical path may be routed through a new physical path. Additionally, the state of the transmission may be locally retained until the prior physical port is no longer undergoing a failure.

### Detailed Description

The present disclosure is directed to path resiliency and recovery mechanism in the communicating nodes. A node (including a remote node) can be reachable by multiple physical ports depending on topology. This information may be maintained as a reachability bitmap. Additionally, there may be many logical paths (from the same or multiple physical ports across slices) through the network fabric (e.g., equal-cost multi-path, or ECMP) leading to the same remote node. An ECMP is represented by a 5 tuple and configured per logical path. As these logical paths are connected to physical ports at sender and receiver nodes, to quickly react to link failures, a path to physical port mapping is maintained which represents the local egress port and remote ingress port connectivity. In case of a link failure, nodes can exchange link status with active remote nodes through control packets, ack and data packets.

In case of link failures locally, remote or in a network fabric, a logical path may transform itself to avoid transmission losses. A local link failure may be detected immediately through link status, and a remote or in fabric path failures may be detected by monitoring the retransmission of packets. In case of transmission failures, a logical path may alter its physical attributes and map itself to a new ECMP path. Path resiliency is implemented in the reliability layer of the transport engine.

A logical path may be assigned sets of ECMP paths, which are represented as path index and associated local egress and remote ingress physical ports. Each set maps the logical path to a different physical path connecting the two nodes. A path index may point to a table storing the 5 tuples associated with the ECMP path. Also, an initiator may monitor the path health and reassigns path mapping in case of path failure. For a link failure identified by hardware, a link failure may immediately move to the next available set. When a link failure is recovered and software enables the link for reuse, the hardware may move back to a different path, which may include some desired or preferred path. For packet drops and retransmission, path trackers may maintain a state (e.g., how many times a packet is retransmitted). After a configurable number of retries, a first path entropy (e.g., L4 source port) is changed. If needed, the set is disabled for a configurable duration and the path is mapped to the next available set.

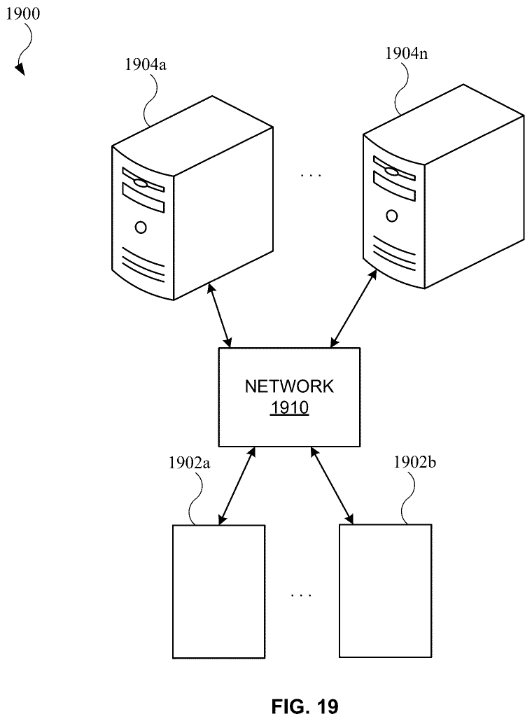

These and other embodiments are discussed below with reference to FIGS. 19, 20, and 21. However, those skilled in the art will readily appreciate that the detailed description given herein with respect to these Figures is for explanatory purposes only and should not be construed as limiting.

FIG. 19 illustrates an example of a network environment 1900 of a system in which data may be shared between devices, in accordance with example aspects of the present disclosure. Not all of the depicted components may be used in all implementations, however, and one or more implementations may include additional or different components than those shown in FIG. 19. Variations in the arrangement and type of the components may be made without departing from the spirit or scope of the claims as set forth herein. Additional components, different components, or fewer components may be provided.

The network environment 1900 may include nodes (e.g., a node 1902a and a node 1902b, representative of additional nodes) and servers (e.g., a server 1904a and a server 1904n, representative of n servers). The network environment 1900 may further include a network 1910 communicatively (directly or indirectly) coupled with one or more of the nodes 1902a through 1902n and one or more of the servers 1904a through 1904 n. The nodes 1902a through 1902n may take the form of computing devices, or processing device, using in training application (e.g., AI training). One or more of the nodes 1902a and 1902b may take the form of a remote node. The servers 1904a through 1904n may take the form of devices that provide data, or information, to the nodes 1902 a through 1902n.

In one or more implementations, the network 1910 may be an interconnected network of devices that may include, or may be communicatively coupled to, the Internet. In the present disclosure, the network 1910 may take the form of an optical network for communication between the nodes 1902a through 1902n and the servers 1904a through 1904n. For explanatory purposes, the network environment 1900 is illustrated in FIG. 19 as including the nodes 1902a through 1902n, the servers 1904a through 1904n, and the network 1910. However, the network environment 1900 may include any number of nodes and/or any number of servers communicatively coupled to each other directly or via the network 1910.

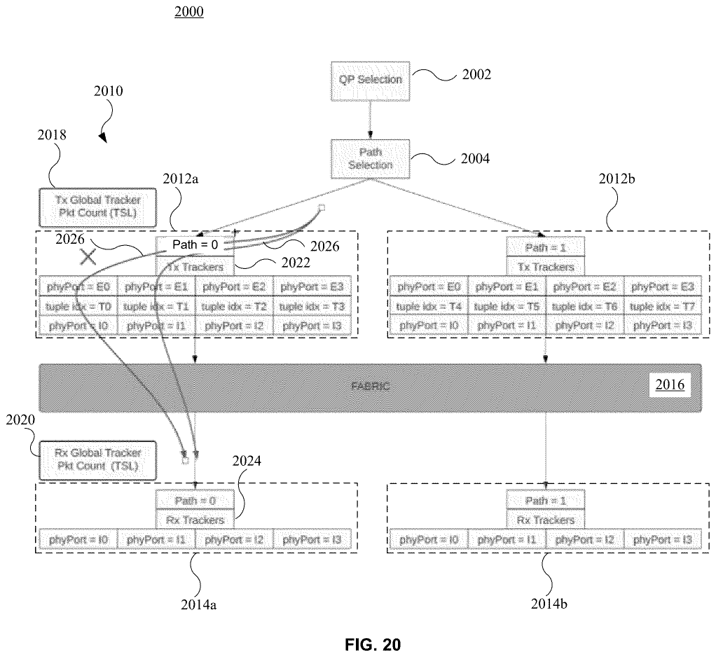

FIG. 20 illustrates a block diagram showing an example embodiment of a system 2000, in accordance with example aspects of the present disclosure. The system 2000 may include a queue pair selector 2002 (QP selector) for distributing network traffic (e.g., data packets, etc.). The queue pair selector 2002 may establish a connection between a pair of nodes (e.g., nodes 1902a and 1902b shown in FIG. 19). The system 2000 may further include a path selector 2004 that select a path for the connection between the nodes connected by the queue pair selector 2002. In one or more implementations, multiple queue pairs are active and the queue pair selector 2002 schedules one of the active queue pairs. Based on multiple path communication, traffic from a queue pair may be distributed and load balanced on multiple paths. FIG. 20 is an example with two (2) paths. It should be noted that there may be multiple simultaneous paths active for a queue pair and traffic is sprayed on them.

The system 2000 may further include a communication channel 2010. As shown, the communication channel 2010 includes a transmitter path 2012a (Path=0) and a transmitter path 2012b (Path=1). The communication channel 2010 may further include a receiver 214a and a receiver 2014b. The transmitter path 2012a and the receiver 2014a may be linked by a fabric 2016 (e.g., network fabric), and the transmitter path 2012b and the receiver 2014b may be linked by the fabric 2016. The fabric 2016 may include a cluster of switches and routers to facilitate communication.

The system 2000 may include several trackers for tracking data packet transmission and receipt. For example, the system 2000 may include a global transmit tracker 2018 (Tx global tracker) and a global receive tracker 2020 (Rx global receiver). These global trackers may track successful transmission and receipt of data packets. Additionally, the transmitter paths 2012a and 2012b, as well as the receivers 2014a and 2014b, may include respective trackers. For example, the transmitter path 2012a may include a transmit tracker 2022 and the receiver 2014a may include a receive tracker 2024. The global transmit tracker 2018, global receive tracker 2020, the transmit tracker 2022 and the receive tracker 2024 may track the state (e.g., success, failure) of transmission of data packets. In one or more implementations, the queue pair traffic is sprayed on multiple paths, the traffic is tracked on all associated paths. The global transmit tracker 2018 may track the overall queue pair progress across all paths.

The transmitter paths 2012a and 2012b, as well as the receivers 2014a and 2014b, may provide several physical paths, or physical links, for communication. The physical paths may be defined by physical ports. For example, the transmitter path 2012a include a path (Path=0) with several physical ports, or transmit physical ports (e.g., phyPort E0 through phyPort E3, phyPort I0 through phyPort I3). Also, the receiver 2014a may include a path (Path=0) with several physical ports, or receive physical ports (e.g., phyPort I0 through phyPort I3).

An exemplary logical path (e.g., for communication of a data pack) through the communication channel 2010 is shown. A logical path 2026 may pass through the transmitter path 2012a through a path (e.g., Path=0), a physical port (e.g., phyPort=E0), the fabric 2016, and the receiver 2014a through a path (e.g., Path=0). In one or more implementations, a failed attempt to transmit and receive a data packet may occur. For example, a link failure through a physical port (e.g., phyPort=E0) of the transmitter path 2012a may occur, causing a failure to transmit the data packet to the receiver 2014a. Such an instance may be determined by, for example, the receive tracker 2024 of the receiver 2014a not providing an acknowledgment of receipt to the transmitter path 2012a. Additionally, a link failure may be determined (e.g., implicitly determined) when the acknowledgment of receipt is not provided within a predetermined time.

When this occurs, the system 2000 may select a different physical path for transmission of a data packet. For example, the logical path 2026 may subsequently pass through the transmitter path 2012a through a path (e.g., Path=0), a physical port (e.g., phyPort=E1), the fabric 2016, and the receiver 2014a through a path (e.g., Path=0). Accordingly, the logical path 2026 may be redefined in part by the physical port (e.g., phyPort=E1). Beneficially, the logical path 2026 may not be tied to a physical path. As a result, when the link failure happens, the logical path 2026 can associate to different physical path and the prior transmission may be retain such that no information is lost due to the link failure. This may be due in part to the transmit tracker 2022 and the receive tracker 2024 (as opposed to the global trackers) monitoring the data packet transmission. In this regard, using the transmit tracker 2022 and the receive tracker 2024 to track the state of transmission may be less complex as compared to the global trackers. Thus, the state of transmission may be locally tracked (e.g., by the transmit tracker 2022 and the receive tracker 2024).

Also, when the data packet is successfully transmitted through the logical path 2026 via the new physical port (e.g., phyPort=E1), the state of the transmission may be transmitted through the new physical port. For example, the receive tracker 2024 may provide the state of transmission to the transmitter path 2012a via the new physical port. Further, during a link failure (e.g., when the link or physical port is down), the transmission to the new physical port is retained until, for example, the prior physical port recovers.

It should be noted that the system 2000 may rely on the remaining physical ports (e.g., phyPort=E2, phyPort=E3) should a link failure occur at a prior physical port. Moreover, the transmitter path 2012b may be utilized should a failure occur to all physical ports of the transmitter path 2012a. Also, the transmitter path 2012a may include multiple physical ports. The traffic sent over the transmitter path 2012a may have transmission states maintained in respective receiver and transmitter trackers. In the event of retransmission of lost packets, the retransmission may always be on the same path. For example, packets sent on the transmitter path 2012a may not be retransmitted on the transmitter path 2012b in the event of a transmission loss. The retransmission may be on the same path (e.g., transmitter path 2012a in this example). Beneficially, this approach may simplify the tracker design such that the global trackers (e.g., global transmit tracker 2018, global receive tracker 2020) are not required to maintain the state to identify duplicate packets (e.g., a packet was delivered to receiver on the transmitter path 2012a, but not acknowledged due to the link being down). If a packet is retransmitted on the transmitter path 2012b, the packet should be filtered by a receiver. If the packet transmitted on same path, then identifying the duplicate packet is relatively easier, as multiple links are available on a path. A link failure may be recovered by mapping the path to a new physical port but retaining the transmission state.

Additionally, the system 2000 may not require firmware and/or software intervention, as the hardware of the system 2000 may recover from the failures. As a result, the reaction time is relatively quick, resulting in enhanced overall performance of the system 2000. Further, as tracker states are retained on port failures, global trackers at the receivers (e.g., global receive tracker 2020) are relatively simple, as the global trackers may not need to track actual packet identifiers. Rather, the global trackers may track only the progress of overall data packet received and sent, which simplifies the receiver side and saves lot of area.

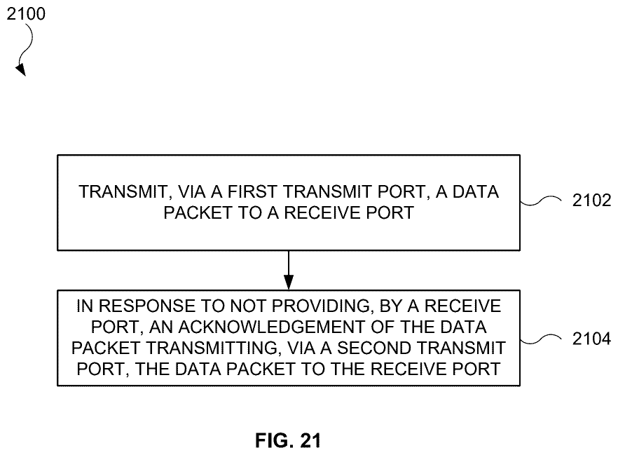

FIG. 21 illustrates an exemplary flowchart showing a process 2100 for transmitting data, in accordance with example aspects of the present disclosure. One or more systems (e.g., the system 2000 shown in FIG. 20) may carry out or perform the blocks described below.

At block 2102, a data packet is transmitted, via a first transmit port, to a receive port. The first transmit port defines in part a first physical path.

At block 2104, in response to not providing, by a receive port, an acknowledgement of the data packet transmitting, via a second transmit port, the data packet to the receive port, wherein the second transmit port defines in part a second physical path different from the first physical path.

### Alternative Embodiments

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of applications and symbolic representations of operations on information. These application descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as components, without loss of generality. The described operations and their associated components may be embodied in software, firmware, hardware, or any combinations thereof.

Any of the steps, operations, or processes described herein may be performed or implemented with one or more hardware or software components, alone or in combination with other devices. In one embodiment, a software component is implemented with a computer program product comprising a computer-readable medium containing computer program code, which can be executed by a computer processor for performing any or all of the steps, operations, or processes described.

Embodiments also may relate to an apparatus for performing the operations herein. This apparatus may be specially constructed for the required purposes, and/or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments also may relate to a product that is produced by a computing process described herein. Such a product may comprise information resulting from a computing process, where the information is stored on a non-transitory, tangible computer readable storage medium and may include any embodiment of a computer program product or other data combination described herein.

The language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed:

1. A method comprising:
receiving a ready byte update, via a sender, corresponding to a local ready byte table entry, wherein a work queue element (WQE) initiates a WAIT WQE to retrieve the ready byte update;
initiating a remote direct memory access (RDMA) to write to a target base table, wherein the initiating indicates that a receiver is ready to receive data;
setting, via a SET WQE, the ready byte to a pending status;
sending one or more messages from the sender to the receiver;
generating a completion queue entry (CQE); and
issuing the SET WQE to set the ready byte table entry available for reuse.

2. A system comprising:
a non-transitory memory with instructions stored thereon; and
a processor operably coupled to the non-transitory memory and configured to execute the instructions of:
receiving, by a trained upsampling model, a low-resolution UV texture image;
generating, by the trained upsampling model, a high-resolution UV texture image based on the low-resolution UV texture image, wherein the generating comprises upsampling the low-resolution UV texture image according to one or more identified features of the low-resolution UV texture image; and
storing the high-resolution UV texture image.

3. A system comprising:
a communication channel associated with a first node and a second node, the communication channel comprising:
a first transmit port configured to transmit, via a network fabric, a data packet from the first node to the second node, wherein the first transmit port defines in part a first physical path,
a second transmit port that defines a second physical path different from the first physical path, and
a receive port configured to receive, via the network fabric, the data packet, the receive port comprising a receive tracker configured to provide an acknowledgement that the data packet is received at the receive port,
wherein in response to the acknowledgement not being received within a predetermined time period through the first physical path, the communication channel is configured to retransmit, via the network fabric, the data packet from the first node to the second node via the second transmit port to the receive port.

4. The system of claim 3, wherein the communication channel is further configured to establish a queue pair between the first node and the second node.

5. The system of claim 3, further configured to:
transmit, via the first transmit port, a data packet to the receive port, wherein the first transmit port defines in part the first physical path; and
in response to not providing, by the receive port, an acknowledgement of the data packet, transmit, via the second transmit port, the data packet to the receive port, wherein the second transmit port defines in part the second physical path different from the first physical path.
